(19) United States
(12) Patent Application Publication
(10) Pub. No.: US 2026/0328199 A1
(43) Pub. Date: Oct. 22, 2026

(54) SYSTEM AND METHOD FOR IMPROVED HEAT PIPE

(71) Applicants: Trustees of Tufts College, Medford, MA (US); Board of Regents, The University of Texas System, Austin, TX (US); Imperial College Innovations Limited, London (GB)

(72) Inventors: Marc Hodes, Medford, MA (US); Hy Dinh, Medford, MA (US); Vaibhav Bahadur, Austin, TX (US); Darren G. Crowdy, London (GB); Michael Mayer, London (GB); Toby Kirk, London (GB)

(21) Appl. No.: 19/108,981

(22) PCT Filed: Sep. 6, 2023
(86) PCT No.: PCT/US2023/073570

§ 371 Date: Mar. 5, 2025

Related U.S. Application Data
(60) Provisional application No. 63/374,674, filed on Sep. 6, 2022.
(60) Provisional application No. 63/484,730, filed on Feb. 13, 2023.
(60) Provisional application No. 63/506,785, filed on Jun. 7, 2023.

(51) Int. Cl. F04B 19/00; B01L 3/00; F04B 49/06

(52) U.S. Cl. CPC F04B 19/006; B01L 3/50273; F04B 49/065; B01L 2300/161; B01L 2300/1894

(57) ABSTRACT

The present disclosure describes a system and method involving a mechanism for a microfluidic pump that leverages alternating adverse and favorable thermocapillary stresses along menisci in a periodically fully-developed internal flow in a microchannel. The system includes interdigitated hot and cold ridges that are asymmetrically disposed relative to each other. The asymmetrical configuration results in different widths of the menisci which drives the microfluidic pump based on the favorable and adverse thermocapillary stresses.

### CROSS REFERENCE TO RELATED APPLICATIONS

The present application is based on, claims priority to, and incorporates herein by reference in its entirety for all purposes, U.S. Provisional Application Ser. No. 63/374,674, filed Sep. 6, 2022; 63/484,730, filed Feb. 13, 2023; and 63/506,785, filed Jun. 7, 2023.

### STATEMENT OF GOVERNMENT SUPPORT

This invention was made with government support under 2140033 awarded by the National Science Foundation. The government has certain rights in the invention.

### BACKGROUND

Heat pipes are ubiquitous in the thermal management of electronics because they can transport heat over relatively long distances, say, 1 m for a 5 mm-OD heat pipe, reliably (per no moving parts), passively and with exceptionally low thermal resistance, no-power consumption and compact, conformable architectures. Heat pipes work by absorbing heat at the evaporator (hot) section, via evaporation of the working fluid. This vapor condenses at the condenser (cold) section of the heat pipe, thereby rejecting heat at that location. In conventional heat pipes, a capillary wick pumps the fluid (passively) back to the evaporator section to continue the cycle. However, capillary forces are limited and not scalable. This implies that the heat transport capacity of conventional heat pipes will reduce with distance.

Hale and Bahadur (IEEE Transaction on Components, Packaging and Manufacturing Technology, 5(10), 1441-1450, (2015)) proposed an electrowetting heat pipe (EHP), whereby the adiabatic section between the evaporator and condenser could be arbitrarily long rather than limited by capillary forces. Essentially, wick-based pumping is replaced by electrowetting-induced pumping of condensate droplets back to the evaporator (Journal of Micromechanics and Microengineering, 27(7), (2017), Characterizing Microfluidic Operations Underlying an Electrowetting Heat Pipe on the International Space Station, (2018)). The mechanism for droplet transport entails a travelling electric field maintaining differing contact angles on the advancing and retreating edges of the droplet. The resulting force imbalance drives the droplet forwards.

While the EHP has enormous promise, its technical feasibility has been restricted due to the following reasons: i) Droplets are challenging to control and prone to merging or splitting, which would affect the microfluidics adversely, ii) Setting up a travelling electric field increases the complexities associated with operating such a heat pipe, iii) degradation of the electrowetting dielectric layer adversely affects the reliability of the device.

### SUMMARY

The present disclosure provides systems and methods that overcome the aforementioned drawbacks by providing systems and methods for microfluidic temperature control. Further, this disclosure describes systems and methods that reduce or eliminate the above-mentioned challenges, while still retaining the benefits of the EHP, such as by relying upon pumping a continuous body of fluid as opposed to droplets and avoid the requirement of a traveling electric field, which simplifies the electronics and control considerably.

In one aspect of the present disclosure, a microfluidic temperature control system is described. The system comprises a microchannel, a first plurality of ridges extending into the microchannel and thermally coupled to a first temperature, and a second plurality of ridges extending into the microchannel and thermally coupled to a second temperature, wherein the first plurality of ridges and the second plurality of ridges form an asymmetrical pattern in the microchannel such that the liquid at adjacent ridges in the microchannel experience differing sing temperature gradients along menisci in a chosen direction. The system further comprises a controller configured to select the first temperature gradient and the second temperature gradient based on the first temperature and the second temperature to form a gradient of surface tension at the interface between two phases along the microchannel to pump liquid through the microchannel.

In another aspect of the present disclosure, a method of operating a microfluidic pump is described. The method comprises cooling a first plurality of ridges extending into a microchannel and heating a second plurality of ridges extending into the microchannel, wherein the first plurality of ridges and the second plurality of ridges form an asymmetrical pattern in the microchannel such that liquid at adjacent ridges in the microchannel experience differing menisci. The method further comprises controlling the cooling of the first plurality of ridges extending into the microchannel and the heating of the second plurality of ridges extending into the microchannel to present Marangoni stresses induced by thermocapillarity in the microchannel.

These aspects are nonlimiting. Other aspects and features of the systems and methods described herein will be provided below.

### BRIEF DESCRIPTION OF THE DRAWINGS

The foregoing features of embodiments will be more readily understood by reference to the following detailed description, taken with reference to the accompanying drawings, in which:

FIG. 1A is a schematic of symmetrically interdigitated electrodes per the prior art.

FIG. 1B is a schematic of an exploded view of asymmetric interdigitated electrodes, according to aspects of the present disclosure.

FIG. 1C is a schematic of the dimensional geometry of the multiphysics problem, according to aspects of the present disclosure. Two periods are shown of a periodic array of hot and cold plates of lengths L* alternating with a period of D* in the x* direction. At zero Reynolds number and zero thermal Péclet number, it is shown that a net pumping of the overlying liquid in the direction indicated can be expected. The pumping speed depends on the meniscus length S*.

FIG. 2 is a schematic of asymmetric interdigitated electrodes of a heat pump, according to aspects of the present disclosure.

FIG. 3 is a schematic of an example thermocapillary pump in a microchannel flow configuration, according to aspects of the present disclosure.

FIG. 4A is a schematic of an interdigitated thermocapillary pump in an internal flow configuration of FIG. 3.

FIG. 4B is a schematic of an interdigitated Maxwell stress pump beneath an unbounded (semi-infinite) liquid of FIG. 3.

FIG. 5 is a schematic of a motor driven by thermocapillary stress asymmetrically imposed on the surface of a rod, according to aspects of the present disclosure.

FIG. 6 is a flowchart an example process of operating a microfluidic pump, according to aspects of the present disclosure.

FIG. 7 is a schematic showing a periodic array of hot and cold plates alternating with unit period in the x direction. Points in the upper half annulus, ρ<|ζ|<1, Im[ζ]>0, are in one-to-one correspondence with points in a principal period window, −½<x<½, y>0. The point α=ir in the upper half of the annulus ρ<|ζ|<1 maps to y→∞. The plates have equal length L and separation S. The values of ρ and r in the ζ plane control L and S in the physical plane with r=√ρ corresponding to the left-right symmetric case where S=(1−2L)/2.

FIG. 8 is a plot of the dimensionless pumping speeds for plates of equal length L=0.05, 0.1 and 0.2 for different values of the separation parameter S. When S=(1−2L)/2 the menisci have the same length and there is no pumping (U_{∞}=0).

FIG. 9 is a series of streamline distributions showing how a purely recirculating mixing flow develops a net pumping component as the plate separation parameter S decreases from the value (1−2L)/2 causing the two meniscus portions in each period window to have different lengths. Here L=0.2 so that when S=0.3 the configuration is left-right symmetric and there is thermocapillary-induced mixing but no pumping.

FIG. 10 is a plot of non-dimensionalized heat load for lates of equal length L=0.05, 0.1, and 0.2 for different values of the separation parameter S.

FIG. 11 is a plot of the efficiency parameter for equal plates and length L=0.05, 0.1 and 0.2 for different values of the separation parameter S. Inset: Sₒₚₜ for different values of the ridge length parameter L.

FIG. 12 is a plot of the dimensionless pumping speeds for plate of equal length L=0.05, 0.1 and 0.2 and S=0.15 for different values of Pe. The dashed lines are the analytical solutions given by equation (58) below.

FIG. 13 is a schematic of the arbitrarily-long electronic heat pipe (ALEHP), according to aspects of the present disclosure.

### DETAILED DESCRIPTION

In the design of microfluidic devices that serve as a laboratory on a chip, there is a need for precise control of small volumes of liquid. Pumping liquid along such a device, typically at very low Reynolds number, is a basic requirement and microfluidic pumps of various kinds have been devised mostly based on the use of pressure differences or electric fields, the latter manifesting themselves as electro-osmosis, electrowetting and electrohydrodynamic.

An interesting theoretical pumping mechanism was advanced by Adjari (Phys. Rev. E, 61(1), R45, (2000)), who proposed an electro-osmotic pump driven by ac fields where broken symmetries of the electrode geometry produce non-zero time-averaged electroosmotic slip velocities at the electrodes, causing unidirectional pumping of the liquid. The mechanism for this theoretical pump has now been tested experimentally and numerical simulations of the underlying mechanism have also been performed. Squires and Bazant (J. Fluid Mech., 560, 65-101, (2006)) have since explored the use of broken symmetries in induced charge electroosmosis and electrophoresis in more general geometrical settings. Adjari ends his paper by emphasizing that it is the intrinsic asymmetry of the device architecture that gives rise to the pumping and suggests that other physical effects, beyond the electroosmotic mechanism he specifically advanced, are viable. However, the paper was focused on the theoretical.

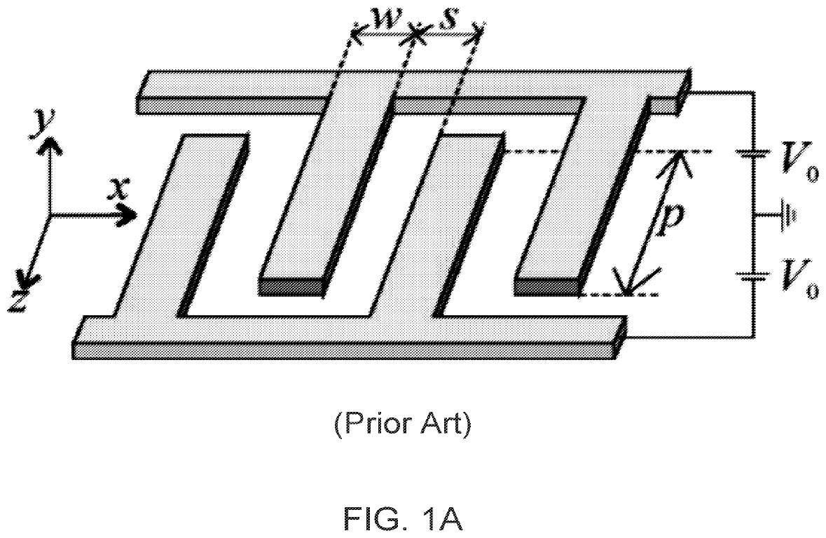

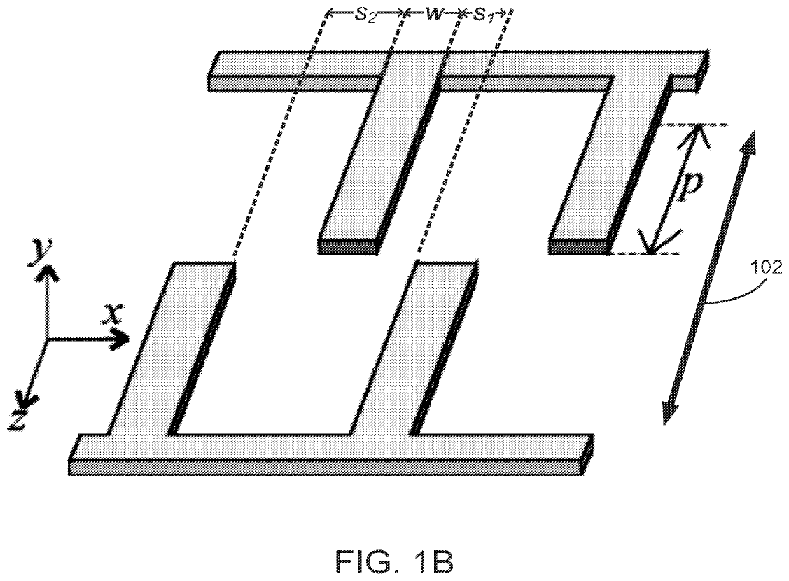

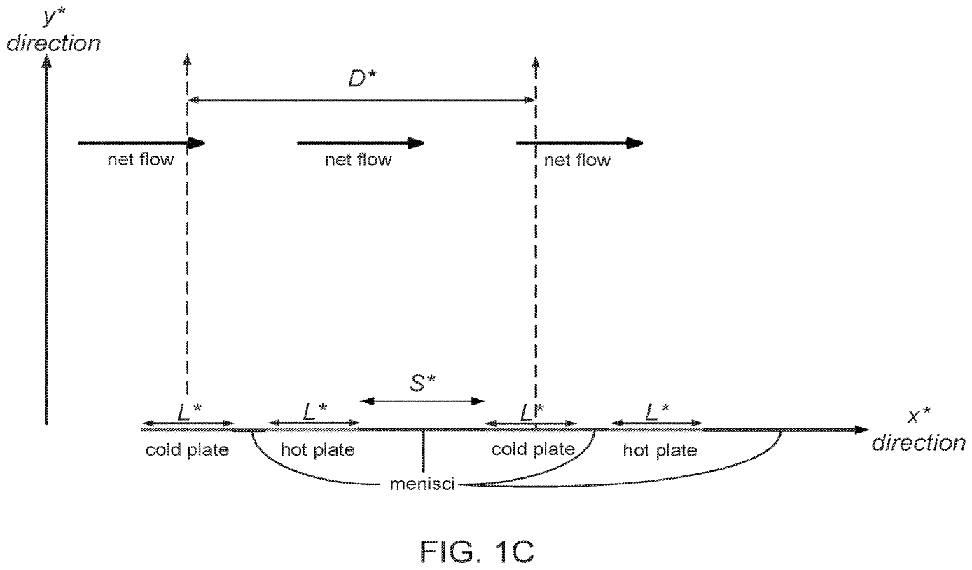

Disclosed herein is a new type of pump, exploiting asymmetry in a device architecture relying on Marangoni stresses induced by thermocapillarity. A feature of the present disclosure is the spacing of interdigitated electrodes from symmetrical (as in the prior art) to asymmetrical. In a symmetrical set-up of FIG. 1A, the width (w) of the strips and the spacing (s) between them is the same on either side of the strips. The strips have a length p, which is assumed to be much larger than both w and s. In a non-limiting example of the design described herein, referencing the non-limiting example illustrated in FIG. 1B, the spacing between the strips is s₁ on one side of each strip and s₂ on the opposite side, where s₁≠s₂. The depiction in FIG. 1B is an exploded view of the interdigitated strips, wherein the arrow 102 indicates that the strips may have other spacing, including at least partially overlapping.

As will be described below, irrespective of the particular configuration, the asymmetry of the systems and methods provided herein can both drive the flow of liquid and perform heat transfer without requiring moving parts, wicking elements, or an adiabatic section, such as in the prior art.

As shown in FIG. 1C, a periodic array of hot and cold plates, all of length L*, alternate with period D* in the x* direction. FIG. 1C shows two periods of this periodic array and a significant feature is that there is both a hot and cold plate in each period window. Importantly, there are also two free surface menisci in each period window which, as indicated in FIG. 1C, are generally of different length; this is quantified by the meniscus length S* (e.g., s₁) shown in FIG. 1C (the length of the other meniscus, e.g., s₂, is then D*−2L*−S*). The surface tension on these menisci varies along them with a linear dependence on the local temperature. This causes Marangoni stresses that incite a non-trivial ow in the overlying liquid and, as will be shown here by solving the multiphysics problem analytically, a net pumping of the liquid far away from the plates assuming zero Reynolds number and zero thermal Péclet number. In example 1 below, a summary of the analytical results is provided: formula (1) provides an explicit, closed-form representation of both the temperature field and velocity field in this cross-section; this section also summarizes two equivalent closed-form expressions, (2) and (3), for the pumping speed.

It is both remarkable and valuable that the solution of a Multiphysics problem of this kind taking place in a nontrivial geometry admits such a concise analytical representation. This solution is valuable not only in exemplifying a basic transport mechanism, but also because it relies on certain technical ingredients that are intrinsic to the device architecture and not specific to the physical driving mechanism. This includes a conformal mapping function to the domain cross-section stated in (1) from a convenient annular preimage domain, as well as a reciprocal theorem result, embodied in (60), that applies in principle to many other physical settings taking place in the same geometry. The motivation for studying this two-dimensional multiphysics problem is how the problem arises from consideration of two “combs”, one hot and another cold, having interdigitated teeth. In cross-section, these teeth form the hot and cold plates shown in FIG. 1C. Indeed, a conceptual design of a pumping device built on the essential mechanism quantified in the example section below is set out.

Thermocapillarity in superhydrophobic microchannels has also been considered. In a theoretical study, Baier et al. (Proc. of 14^{th} International Conference on Miniaturized System for Chemistry and Life Sciences, 1799-1801, (2010)) imposed a unidirectional temperature gradient along a (parallel or transverse) ridge-type superhydrophobic microchannels to drive a flow of water through them at several mm/sec for a 10° C./m temperature gradient. This flow configuration limits the streamwise length of the pump to the distance required for the liquid to freeze as results from the requisite decreasing (increasing) temperature (surface tension) in the streamwise direction, a constraint not imposed by the pumping mechanism considered here.

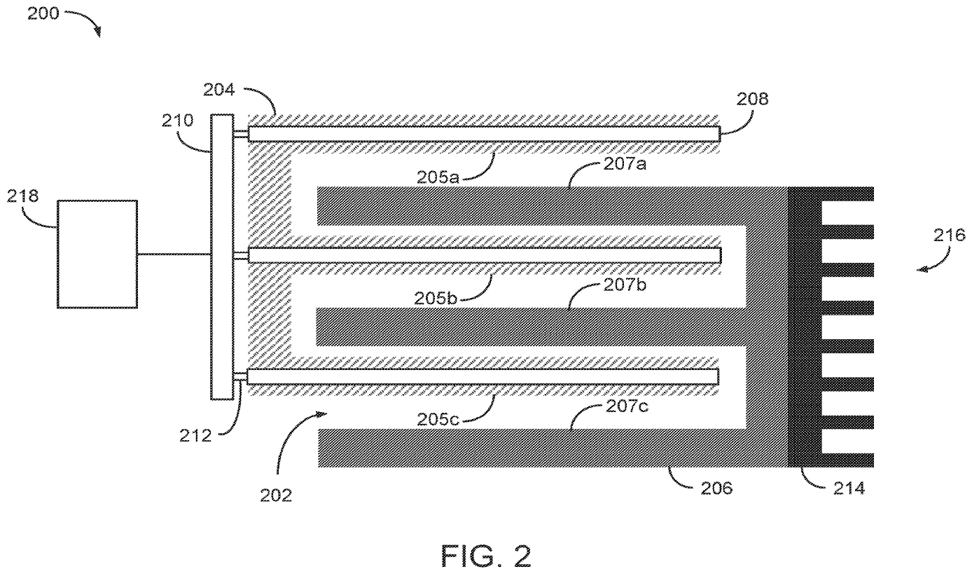

A non-limiting example of a system 200 is shown in FIG. 2. In the example of FIG. 2, a microchannel 202 includes a first plurality of ridges 204 extending into the microchannel 202. The system 200 further includes a second plurality of ridges 206 extending into the microchannel 202. In a non-limiting example, the first and second plurality of ridges 204, 206 form an asymmetrical pattern in the microchannel 202. As used this setting, “asymmetrical” can refer to the spacing between interdigitated ridges, such that an individual ridge is closer to an adjacent ridge of the interdigitated plurality of ridges on one side that the other.

In a non-limiting example, the first and second plurality of ridges 204, 206 can be thermally conductive. A first plurality of ridges 204 includes a heating element 208 embedded within each of the of the ridges 205a-205c. In a non-limiting example, a heating element 208 may be embedded in fewer than all of the ridges of the first plurality of ridges 204. In one example, the heating elements 208 are embedded in the center of the ridge such that the ridge is evenly heated. These heating elements 208 are thermally coupled to a heat source 210 via conductive wires or leads 212 for providing thermal energy to the heating elements 208 and first plurality of ridges 204. The heat source 210 may be any source of heat. In some embodiments, the heat source 210 is an electronic device configured to produce heat when energized, such as, a microprocessor, power amplifier, or high-power laser. In other embodiments, the heat source may be a source of waste heat such as, e.g., a smokestack or a catalytic converter of an automobile. In another embodiment, the heat source may be solar energy. The system 200 may be further configured to cool the heat source 210, to maintain a temperature thereof, or to recover power from the waste heat. In still other embodiments, the heat source 210 may be a passive device, such as a sensor that does not dissipate heat, but is maintained by the system 200 at a desired operating temperature.

In a non-limiting example, the second plurality of ridges 206 are thermally coupled to a heat sink 214 to passively dissipate heat out of the ridges 207a-207c. In a non-limiting example, the heat sink 214 includes a plurality of fins 216 to increase the surface area of the heat sink 214 to enhancing heat dissipation. In a non-limiting example, the heat sink 214 is made of aluminum or copper. Alternatively, the heat sink 214 may be an active heat sink. Active heat sinks include, but are not limited to, assemblies with fans or blowers. Another type of active heat sink involves pumped liquid to remove latent heat from the second plurality of ridges 206.

It is noted that that plurality of ridges 206 thermally coupled to the heat sink 214 may be the “first” plurality of ridges and the plurality of ridges 204 thermally coupled to the heating elements 208 and heat source 210 may be the “second” plurality of ridges. As used herein, the terms “first” and “second” are only used to distinguish between the two set of ridges and not to indicate any chronological order.

This example system 200 relies on the temperature difference between the first plurality of ridges 204 and second plurality of ridges 206 to generate a temperature gradient. When a liquid is introduced into the microchannel 202, the liquid at adjacent ridges experiences differing signs temperature gradients along menisci in a chosen direction.

Alternatively, the second plurality of ridges 206 may also include heating elements such as the heating elements 208 embedded in the first plurality of ridges 204. In this example, only a difference in temperature to generate a temperature gradient is required to promote fluid flow, thus the temperature of the first plurality of ridges 204 and the temperature of the second plurality of ridges 206 need only be de different.

In a non-limiting example, the heat source 210 is electrically coupled to a controller 218 configured to select the first temperature gradient and the second temperature gradient based on the first temperature of the first plurality of ridges 204 and the second temperature of the second plurality of ridges 206 to form a gradient of surface tension at the interface between two phases along the microchannel 202 to pump liquid through the microchannel. In a non-limiting example, the controller is configured to control a rate of heat transport between first and second plurality of ridges 204, 206. In another example, the controller may act as an active feedback loop to maintain a given temperature of the first plurality of ridges 204, second plurality of ridges, and/or the temperature gradients in the microchannel 202.

While the first and second plurality of ridges 204, 206 are each shown having three ridges 205a-205c and 207a-207c, embodiments are contemplated having fewer or more ridges. The first and second plurality of ridges 204, 206 may have the same number of ridges, as illustrated in FIG. 2, but embodiments having unequal numbers of ridges are within the scope of this disclosure. In this non-limiting example, the ridges are asymmetrically interdigitated.

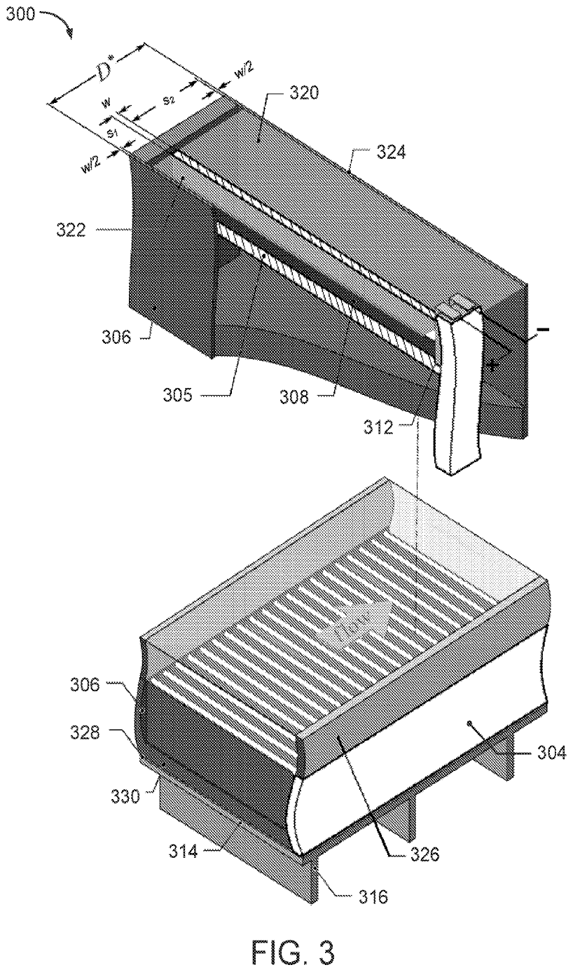

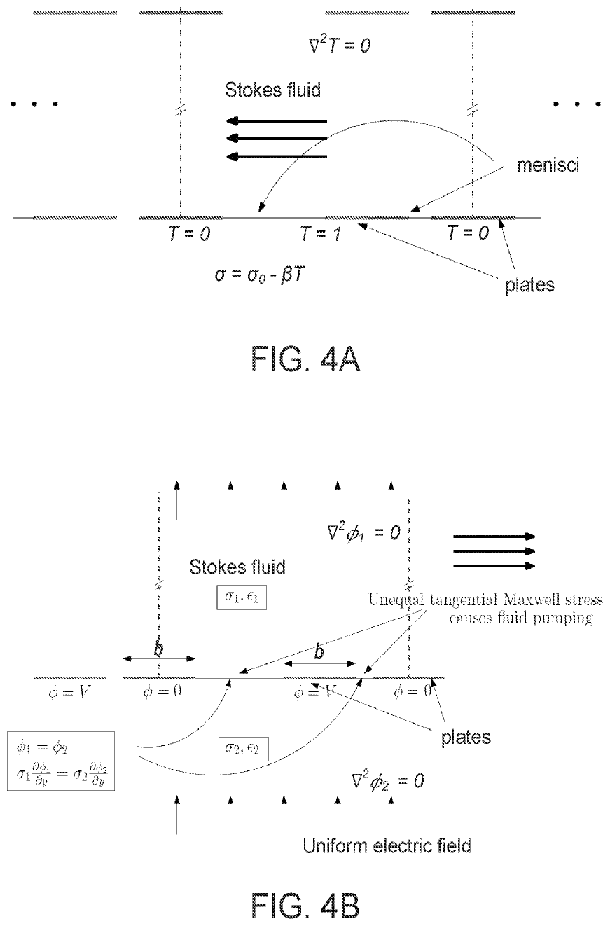

Referring now to FIG. 3, an exemplary pump is shown wherein the core of the pump is two (asymmetrically) interdigitated “combs,” a cold one having a base, spine and teeth (ridges) and a hot without a base. Both are microfabricated in a high thermal conductivity material (for example, silicon) such that they are essentially isothermal, and have a hydrophobic coating on their tips. The cold comb is attached to a heat sink via a layer of thermal interface material (TIM) in order to maintain it near ambient temperature. Alternatively, a sub-ambient temperature may be obtained by inserting a thermoelectric module between the TIM and heat sink. A current driven through thin-film heaters deposited on the teeth of the hot comb (say, by sputtering TiW) maintains the requisite temperature excursion relative to the cold comb. The teeth of the hot comb are deliberately shorter than those of cold one to minimize the transfer of heat to the cold one. A crucial feature is the asymmetry in the spacing between the ridges. As shown in the inset, for the flow direction shown, the meniscus subjected to adverse thermocapillary stress (i.e., temperature (surface tension) increase (decrease) in the flow direction) is shorter than the one subjected to a favorable stress. Since the flow is hydrodynamically and thermally fully developed there is solely a periodic component of the pressure and temperature fields and the rate of heat transfer into the liquid along the tip of a hot tooth equals that transferred out of it along the tip of a cold one.

In this non-limiting example of a microfluidic temperature control system 300, structures described above in FIG. 2 are similarly used herein. In a non-limiting example, an individual ridge 305 of the first plurality of ridges 304 is shown, whereby on one side of the ridge a favorable stress meniscus 320 forms and on the other side an adverse stress meniscus 322. In a non-limiting example, the surface of the first plurality of ridges includes a hydrophobic coating 324 to maintain the Cassie or unwetted state of the liquid. As conveyed in FIG. 2 above, the individual ridge 305 of the first plurality of ridges 304 includes a heating element 308 thermally coupled to a heat source (not shown in FIG. 3) via leads 312. In a non-limiting example, the system 300 further includes a microchannel wall 326.

In this non-limiting example, the second plurality of ridges 306 asymmetrically interdigitates with the first plurality or ridges 304. As in FIG. 2, the second plurality of ridges 306 is thermally coupled to a heat sink 314 with a plurality of fins 316. In a non-limiting example, the second plurality of ridges 306 are thermally coupled to the heat sink 314 via a thermal interface material (TIM) 328 and a base 330. In this embodiment, the TIM 328 helps to maintain the second plurality of ridges 306 at near-ambient temperature. Alternatively, a sub-ambient temperature may be obtained by inserting a thermoelectric module between the TIM 328 and heat sink 314.

In the non-limiting example of FIG. 3, as with FIG. 2, the first plurality of ridges 304 may form the higher temperature ridges. In one example the higher temperature ridges 304 are shorter in length than the ridges in the second plurality of ridges 306 in order to minimize the transfer of heat to the second plurality of ridges 306.

As will be described in further detail below, the asymmetry of the interdigitated ridges provides the environment for fluid flow. Specifically, and as shown by the flow direction in FIG. 3, the meniscus 322 subjected to adverse thermocapillary stress is shorter than the meniscus 320 subjected to a favorable stress. Since the flow is hydrodynamically and thermally fully developed, there is solely a periodic component of the pressure and temperature fields and the rate of heat transfer into the liquid along the tip of a higher temperature ridge equals that transferred out of it along the tip of a lower temperature ridge.

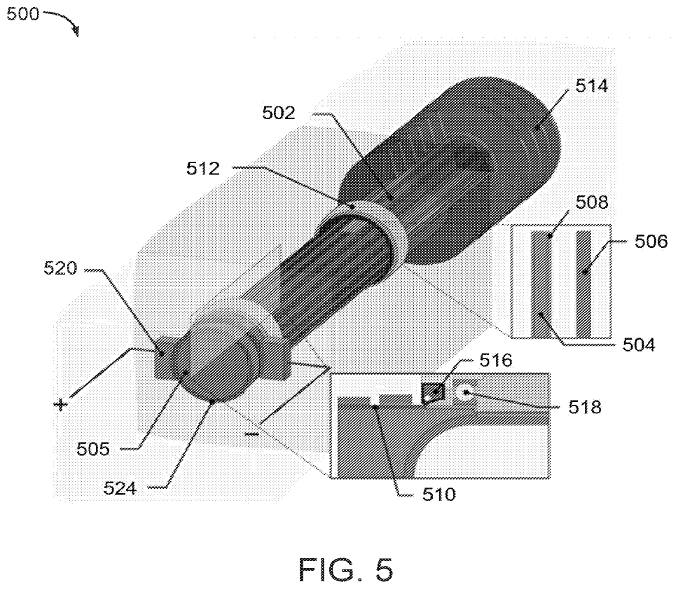

In another aspect of the present disclosure, the thermocapillary action applied to a two-dimensional geometry as described in the examples above is also applicable to three-dimensional geometries. For example, the microfluidic system may be wrapped in the shape of a cylindrical rod (FIG. 5). Imposing forces (or torques) can be imparted on cylindrical shafts in a quiescent liquid via heat transfer phenomena and/or Maxwell stresses. Though the net, steady-state, force on the shaft is identically zero, it will spin prior to coming to a halt under steady-state conditions. In a first asymmetrical setting of the interdigitated ridges, the rod will spin prior to coming to a halt at steady-state condition. In a non-limiting example, the spinning can drive a mechanical load or a motor by the thermocapillary stress asymmetrically imposed on the surface of a rod. Once at steady-state and the rod has ceased spinning, the interdigitated ridges may be set to a second symmetrical setting. For example, the spacing s₁ and s₂ switch values between the first and second setting, such that the rod rotates in the opposite direction to reach a steady state again.

In a non-limiting example switching between the first and second setting may occur automatically. For example, a timer may be used to periodically switch between the states. In another example, a rotation sensor may be used to sense the rotation of the rod. Alternatively, the switching may be performed manually. In one example, both the first and second plurality of ridges are movable relative to each other to adjust the values of s₁ and s₂. In another example, only one of the first or second plurality of ridges is movable to adjust the values of s₁ and s₂.

In the example of FIG. 5, a continuously-operating motor may be developed. For example, one application for such a system is using the heat from solar energy to drive the pump (i.e., as the heat source 210) as well as for generating electrical power in conventional solar panels. In the latter case, energy in the solar spectrum from a laboratory source may be focused on a heat source or heating element of the first plurality of ridges 504. The second plurality of ridges 506 may be coupled to a heat sink, i.e., “thermal ground.” In this non-limiting example, thermocapillarity may be used to generate electric power. This may have profound long-term implications for energy harvesting because commercial solar panels are only able to convert about 20% of the incident radiative energy into electricity, whereas here all of it may be used to drive heat out of the first plurality of ridges and into the surrounding liquid. The Carnot limit of the efficiency of solar power is about 95% as the surface of the sun is near 6000K. For example, a higher efficiency energy conversion may be achieved over conventional solar cells in solar-to-electrical energy conversion.

In a non-limiting example, the system 500 includes a heat pipe 502, such as any of the heat pipes presented in the examples above. Alternatively, the heat pipe 502 may be an axial-groove heat pipe (AGHP), wherein the first plurality of ridges 504 and second plurality of ridges 406 are arranged axially along the rod as shown in FIG. 5. In a non-limiting example, the first plurality of ridges are coupled to a ceramic comb 505. Further, the first plurality of ridges 504 may include a heating element 508 thermally coupled to the first plurality of ridges 504 as previously conveyed. The heating element 508 may be a titanium-tungsten (TiW) alloy.

The system 400 further includes leads 510 electrically coupled to the heating element 508 of the first plurality of ridges 504. In a non-limiting example, the leads 510 may be a copper leads. Since the embodiment in FIG. 5 is configured to rotate, the system may further include one or more rotary shaft seals 512 including gaskets 516 and bearings 518.

Further shown in FIG. 5 are a plurality of annular fins 514. System 500 may further include an electric brush 520 contacting a ring electrode 524.

Additionally, heliostats and miniaturized version of the system 500 may be used to focus solar energy on the hot side of the device: e.g., the evaporators section of a heat pipe. One may consider the use of liquid metal (say, Galinstan) rather than water as the fluid surrounding the shaft. It is nonvolatile and has a very high boiling point (over 1000K) at ambient pressure; therefore, phase change will not occur. Since it's a liquid metal, moving in a magnetic field, a voltage may be developed and used for a magnetohydrodynamic power generator.

In the case of a volatile liquid (such as, water, or alcohol, where re-entrant structures are required to stabilize the liquid in the non-wetting (Cassie-Baxter) state) evaporation and condensation can occur near the hot and cold ridges along the shaft. The same asymmetry in the topography as shown in FIG. 5 may be used to generate rotation as it could be used to generate flow in the pumping embodiment.

FIG. 5 was drawn in a cylindrical coordinate-based device (shaft), standard motor/generator. However, the same physics will work in a Cartesian based device, say, to build a linear motor or generator.

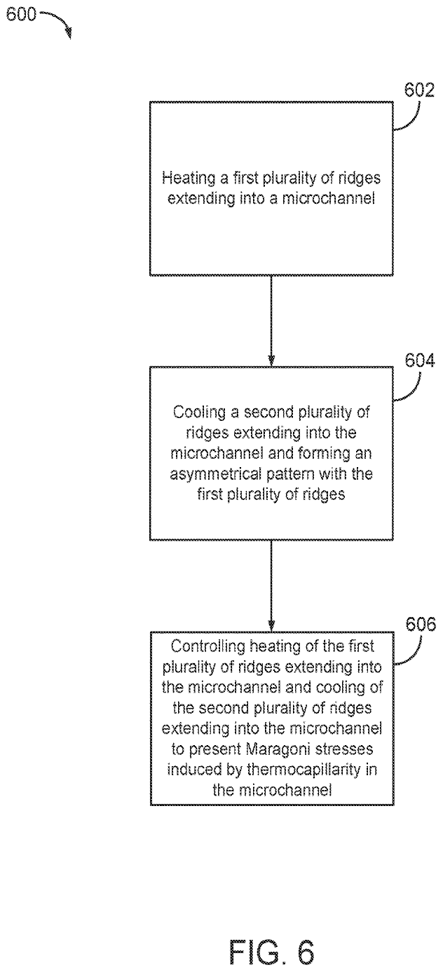

In another aspect of the present disclosure, a method of operating a microfluidic pump 600 is described (FIG. 6). In a non-limiting example, the method comprises cooling a first plurality of ridges extending into a microchannel at step 602. Cooling the first plurality of ridges may involve the use of passive or active heat sinks as previously described. At step 604, the method includes heating a second plurality of ridges extending into the microchannel, wherein the first and second plurality of ridges positioned relative to each other such that they form an asymmetrical pattern. Heating the second plurality of ridges may be done using any of the heating methods as described above with reference to FIG. 2. In a non-limiting example, steps 602 and 604 may be performed in reverse, whereby heating the second plurality of ridges occurs before cooling the first plurality of ridges. Alternatively, steps 602 and 604 may occur substantially simultaneously.

In a non-limiting example, the method comprises controlling the cooling of the first plurality of ridges extending into the microchannel and heating the second plurality of ridges extending into the microchannel to present Marangoni stresses induced by thermocapillarity in the microchannel at step 606.

In a non-limiting example, a working fluid introduced into the microchannel is moved from a first end of the microchannel to a second end of the microchannel by the Maragoni stresses. A detailed explanation of Marangoni stresses will be provided in the example section below.

The following examples are provided to demonstrate and further illustrate certain embodiments and aspects of the present invention and are not to be construed as limiting the scope of the invention.

### Example 1

To summarize now the main theoretical results, it is shown here that the stream function ψ* associated with a model of the Marangoni-induced flow of a viscosity-μ* liquid, and the associated temperature field T* causing the thermocapillary stress, are given parametrically, in terms of a parametric complex variable (sitting in an upper-half annulus ρ<|ζ|<1, Im[ζ]>0, by the explicit formulas

$${ψ}^{★} = Im [ ( \overline{{Z}^{★} ( ζ )} - {Z}^{★} ( ζ ) ) \frac{i βΔ {T}^{★}}{4 {μ}^{★}} [ \frac{1}{2} + {\sum }_{n \geq 1}^{∞} \frac{2}{1 + {ρ}^{n}} ( \frac{1 - {( - 1 )}^{n}}{{( π n )}^{2}} ) ( {ζ}^{n} + \frac{{ρ}^{n}}{{ζ}^{n}} ) ] ] , \qquad ( 1 )$$

$${T}^{★} = Im [ Δ {T}^{★} ( i - \frac{1}{π} log ζ ) ] ,$$

$${𝓏}^{★} = {x}^{★} + {iy}^{★} = {Z}^{★} ( ζ ) = - \frac{{iD}^{★}}{2 π} log [ R \frac{P ( ζ / α , β ) P ( α , ρ )}{P ( ζ / \overline{α} , β ) P ( \overline{α} , ρ )} ] , α = ir ,$$

where ΔT* is the temperature difference between the hot and cold combs, β* captures the effect of temperature change on surface tension, D* is the period length, and P(ζ, ρ) is a special function associated with the annulus and defined in (12). The * superscripts signify a dimensional parameter. The two parameters ρ and r determine the geometry of the device architecture as explained later; all other parameters in (1) will also be explained in the main body of the paper. It is both remarkable and valuable that the solution of a multiphysics problem of this kind taking place in a nontrivial geometrical architecture admits such a concise analytical representation.

This explicit mathematical solution is valuable not only in exemplifying a basic transport mechanism, but also because it relies on certain technical ingredients that are intrinsic to the device architecture and not specific to the physical mechanism: this includes the conformal mapping function (1) from a convenient annular preimage domain, and a reciprocal theorem result that applies in principle to many other physical settings taking place in the same device architecture. Indeed, it is shown here that one formula for the pumping speed U_{∞}* follows directly from the full solution (1), namely,

$${U}_{∞}^{★} = \frac{{β}^{★} Δ {T}^{★}}{{μ}^{★}} \times \frac{2}{{π}^{2}} {\sum }_{m \geq 1}^{∞} \frac{{( - 1 )}^{m + 1}}{{( 2 m - 1 )}^{2} ( 1 + {ρ}^{2 m - 1} )} ( {r}^{2 m - 1} - {( \frac{ρ}{r} )}^{2 m - 1} ) . \qquad ( 2 )$$

But another formula given by

$${U}_{∞}^{★} = \frac{{β}^{★} Δ {T}^{★}}{{μ}^{★}} \times ( - \frac{1}{4 {π}^{2}} ) \times ( {\int }_{{C}_{0}^{+}} - {\int }_{{C}_{1}^{+}} ) log \vert \frac{P ( ζ / α , ρ ) P ( ζ \overline{α} , ρ )}{P ( ζ / α , ρ ) P ( ζ \overline{α} , ρ )} \vert \frac{d ζ}{i ζ} \qquad ( 3 )$$

follows from the reciprocal theorem for Stoke flow combined with knowledge of an exact solution due to Crowdy (Phys. Fluids, 23, 072001, (2011)) for a problem of shear flow over periodic arrays of shear-free menisci relevant to studying hydrodynamic slip over superhydrophobic surfaces. Interestingly, formula (3) does not require finding the solution of the full multiphysics problem, only the solution for the temperature field causing the thermocapillary stress.

This is not the first time thermal effects have been proposed as a microfluidic pumping mechanism and thermocapillarity can play an important role in small scale fluid manipulation of discrete droplets. Temperature gradients have also been used to direct fluid motion on selectively patterned surfaces. The use of thermocapillarity in flow geometries akin to that proposed in the present paper, with the Marangoni stresses being active on menisci spanning interstitial grooves between pillars or gratings, has also been considered before but in all those prior studies a unidirectional (rather than periodic) temperature gradient is externally imposed to drive the system. This limits the streamwise length of the pump to the distance required for the liquid to freeze as results from the requisite decreasing (increasing) temperature (surface tension) in the streamwise direction. This is a severe constraint not shared by the new pumping mechanism proposed herein. It is also noted that the degradation in lubrication due to the effects of adverse thermocapillary stresses on pressure-driven flow through heated, superhydrophobic microchannels has been quantified.

In the design of heat pipes the use of electrowetting mechanisms acting on discrete droplets has also been proposed as a means to pump condensate to the evaporator. Such proposals aim to overcome transport limits associated with use of capillary pressure in more traditional wicks, i.e., enable a heat pipe to arbitrarily long rather than constrained by a performance limit such as the capillary limit. Another advantage of the pump put forward here is that it pumps a continuous stream of fluid without the need for the discretization into droplets necessary to facilitate contact angle differentials fore and aft on which such electrowetting devices rely. The present invention has been described in terms of example embodiments, and it should be appreciated that many equivalents, alternatives, variations, additions, and modifications, aside from those expressly stated, and apart from combining the different features of the foregoing versions in varying ways, can be made and are within the scope of the invention. While the above detailed description has shown, described, and pointed out novel features as applied to various embodiments, it will be understood that various omissions, substitutions, and changes in the form and details of the devices or algorithms illustrated can be made without departing from the spirit of the disclosure. As will be recognized, certain embodiments of the disclosures described herein can be embodied within a form that does not provide all of the features and benefits set forth herein, as some features can be used or practiced separately from others. The scope of certain disclosures disclosed herein is indicated by the appended claims rather than by the foregoing description. All changes which come within the meaning and range of equivalency of the claims are to be embraced within their scope.

### Physical Description of the Pump

A simple theoretical model of the basic pumping mechanism, one that turns out to be exactly solvable, results from the hydrodynamically and thermally (periodically) full-developed flow assumption and taking a cross-section through the interdigitated teeth of the two combs and away from their spines. In such a cross-sectional view the interdigitated tips of the teeth will form what will be referred to as alternating hot and cold “plates” in an x*-periodic array with period length D*. In each period window there will be two plates, one hot and another cold and both of length L*, as well as two menisci. The hot and cold plates are separated by a distance S*. It is assumed that a μ*-viscosity semi-infinite liquid exists above the periodic plates in the Stokes regime typical of many microfluidic and small scale applications.

The objective is to achieve liquid pumping in the direction parallel to the spine of each comb using thermocapillary-induced Marangoni stresses. It is assumed that, along the menisci between the interdigitated teeth of each comb, surface tension σ* depends on temperature T* according to a linear relation

σ*=σ_{c}*−β*T*. (4)

where σ* is the surface tension of the liquid at reference temperature T* and the coefficient β* corresponds to the chosen liquid. Since Marangoni stresses are dependent only on gradients of surface tension the values of σ* and T* do not appear in the subsequent analysis. Gravity is neglected and the (thermal) Péclet number is taken to be zero so that all of the heat dissipated by the hot ridge conducts into the and through liquid to the cold one but there is no advection. A (one-way) coupling of the temperature field with the liquid motion is nevertheless caused by the non-uniform temperature varying the surface tension on the menisci between the interdigitated teeth of the combs. This induces Marangoni stresses on the viscous liquid resulting in mixing of the liquid and, as will be shown here, a net pumping of the liquid when the two combs are appropriately offset so that the alternating menisci between the interdigitated teeth of the combs have different lengths. The limiting case of symmetrically-positioned ridges only provides mixing.

### Analysis of the Theoretical Model

The Stokes equations governing the two-dimensional liquid motion can be represented in stream function form as

∇⁴ψ*=0. (5)

where u* and v*, the velocities in the x* and y* directions, are related to the stream function ψ* by

$${u}^{★} = \frac{\partial {ψ}^{★}}{\partial {y}^{★}} , {v}^{★} = - \frac{\partial {ψ}^{★}}{\partial {x}^{★}} . \qquad ( 6 )$$

The assumption is that the thermal Péclet number vanishes means that the temperature field is governed by Laplace's equation

∇²T*=0. (7)

The two plates are taken to be no-slip surfaces with the plate occupying y*=0, S*<x*<0 held at temperature T*=ΔT*. The other plate is held at T*=0. On the two menisci, a thermal Marangoni condition couples the temperature field and velocity field via

$${μ}^{★} = \frac{\partial {u}^{★}}{\partial {y}^{★}} = - \frac{\partial {σ}^{★}}{\partial {x}^{★}} = {β}^{★} \frac{\partial {T}^{★}}{\partial {x}^{★}} . \qquad ( 8 )$$

The velocity is assumed to reach some constant value, U_{∞}*, far from the composite boundary. The problem can be cast into dimensionless form using

$$𝓏 = \frac{{𝓏}^{★}}{{D}^{★}} , L = \frac{{L}^{★}}{{D}^{★}} , S = \frac{{S}^{★}}{{D}^{★}} , ( u , v ) = \frac{{μ}^{★}}{{β}^{★} Δ {T}^{★}} ( {u}^{★} , {v}^{★} ) , \qquad ( 9 )$$

$$ψ = \frac{{ψ}^{★} {D}^{★} {μ}^{★}}{{β}^{★} Δ {T}^{★}} , p = \frac{{p}^{★} {D}^{★}}{{β}^{★} Δ {T}^{★}} , T = \frac{{T}^{★}}{Δ {T}^{★}} ,$$

where p* is the liquid pressure. All the equations stated earlier remain largely unchanged, the only adjustments being to the constant temperature condition on the hot plate, where now T=1, and the Marangoni condition, where now

$$\frac{\partial u}{\partial y} = - \frac{\partial T}{\partial x} . \qquad ( 10 )$$

The dimensionless problem additionally comes with two dimensionless numbers Re=ρ*U*D*/μ* and Pe=U*D*/α*, the Reynolds number and thermal Péclet number, respectively; here ρ* is the liquid's density and α* its thermal diffusivity. These two parameters are assumed to be zero as stated earlier, but their definition is included for discussion later.

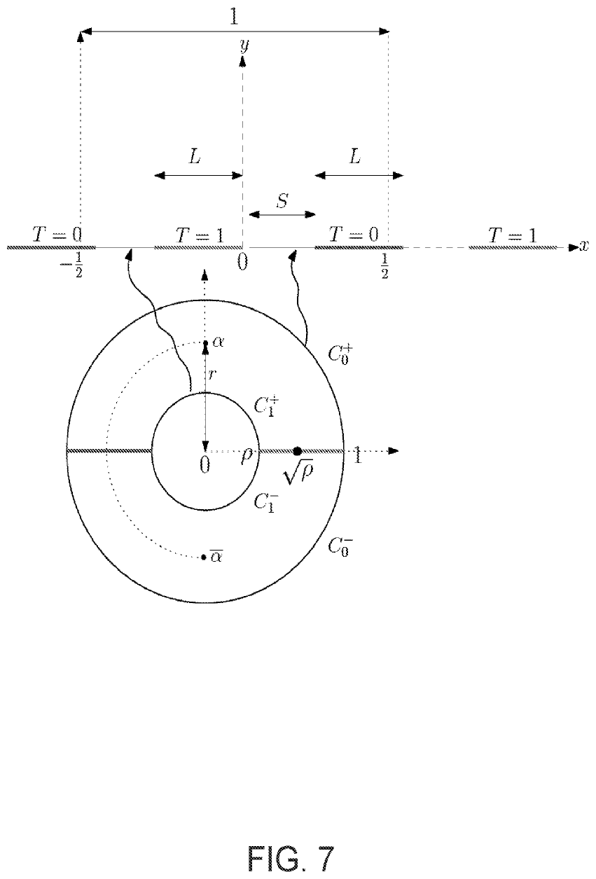

FIG. 7 shows a schematic of the flow domain after the aforementioned non-dimensionalization. It shows how the non-dimensional plate separation parameter S is defined as the length of the meniscus to the right of a typical hot plate; the meniscus length to its left will then be 1−2L−S. It is important to note that while it is taken that both plates to have the same length L, the lengths of these two menisci can be different. When the two menisci have the same length, so that S=1−2L−S, or S=(1−2L)/2, no liquid pumping is expected due to the left-right symmetry of the configuration in that case. But when the two menisci have different lengths it will be shown, by solving analytically for the temperature field and, subsequently, the induced Stokes flow of the viscous liquid, that a net pumping of the fluid is achieved.

### Conformal Mapping

By the unit periodicity of the arrangement, it is enough to consider the flow in a principal period window −½<x<½, y>0. The analysis to follow will make use of a conformal mapping already used in the study by Crowdy of so-called superhydrophobic surfaces (characterized by shear-free menisci existing between no-slip plates) but will be deployed here in a different context. The advantage of introducing a parametric conformal mapping variable (is that both the temperature problem and the flow problem can be solved explicitly as functions of it. The relevant mapping, from a parametric annulus ρ<|ζ|<1, is

$$𝓏 = Z ( ζ ) = - \frac{i}{2 π} log [ \frac{P ( ζ / α , ρ ) P ( ζα , ρ )}{P ( ζ / \overline{α} , ρ ) P ( ζ \overline{α} , ρ )} ] , \qquad ( 11 )$$

where α=ir for ρ<r<1, and

$$P ( ζ , ρ ) ≡ ( 1 - ζ ) {\prod }_{n = 1}^{∞} ( 1 - {ρ}^{2 n} ζ ) ( 1 - {ρ}^{2 n} / ζ ) . \qquad ( 12 )$$

This important function (12) can be identified with the prime function associated with the concentric annulus ρ<|ζ|<1. The constant R is chosen to be

$$R = \frac{P ( 1 / \overline{α} , ρ ) P ( \overline{α} , ρ )}{P ( 1 / α , ρ ) P ( α , ρ )} \qquad ( 13 )$$

which ensures that Z(1)=0. Under the mapping (11) the upper-half annulus, ρ<|ζ|<1, Im[ζ]>0, is in one-to-one correspondence with the liquid in a principal period window as shown in FIG. 7. The upper unit semicircle, denoted by

$${C}_{0}^{+} ,$$

maps to one of the menisci (with the lower half of the unit circle, denoted by

$${C}_{0}^{-} ,$$

also mapping to the same meniscus); the upper semicircle of radius ρ, denoted by

$${C}_{1}^{+} ,$$

maps to the other meniscus (with the lower half of the radius ρ circle, denoted by

$${C}_{1}^{-}$$

also mapping to the same meniscus). The segment ΔT on the positive real axis is transplanted to the hot plate in the period window held at temperature ΔT, the portion [−1,−ρ] on the negative real axis maps to the cold plate held at zero temperature.

The mapping (11) depends on the two real positive parameters ρ and r satisfying 0≤ρ<1, ρ<r<1. These two mathematical parameters are related to the two geometrical parameters L and S also shown in FIG. 7. Indeed, as indicated in FIG. 7, the mapping is such that

Z(−1)=S, Z(−ρ)=S+L (14)

and these two equations provide nonlinear algebraic relations between the parametric pair {ρ, r} and the geometrical pair {L, S}. It will then follow, from the functional form of the mapping, that

Z(ρ)=−L. (15)

One can pick {ρ, r} and find {L, S} using the explicit relations (14). Alternatively, if the pair {L, S} is specified, then (14) must be solved (e.g., using a simple Newton method) for the corresponding {ρ, r}.

It is worth remarking that the requirement that the plates be of equal length is not necessary and can easily be relaxed. Mathematically, this is done simply by allowing the parameter α in (11) to move off the imaginary axis so that it is a more general point in the upper-half annulus ρ<|ζ|<1, Im[ζ]>0.

### Solution for the Temperature Field

The non-dimensional version of (7) governing the temperature T is

$${∇}^{2} T = 0 , - \frac{1}{2} < x < \frac{1}{2} , y > 0. \qquad ( 16 )$$

The two menisci are taken to be adiabatic so that

$$\frac{\partial T}{\partial y} = 0 , on the menisci . \qquad ( 17 )$$

The hot and cold plate are such that

$$T = \{ \begin{matrix}1 , & on the hot plate , \\ 0 , & on the cold plate .\end{matrix} \qquad ( 18 )$$

It is assumed that no heat enters the system from the far-field so that heat entering each period window through the heated plate is conducted away through the cooler plate.

The temperature field T(x, y) will be found by determining the analytic function

w(z)=χ+iT, z=x+iy, (19)

where χ is the harmonic conjugate to T in the liquid region and the usual complex variable z=x+iy has been introduced. On use of one of the Cauchy-Riemann equations, namely

$$\frac{\partial χ}{\partial x} = \frac{\partial T}{\partial y} , \qquad ( 20 )$$

then (17) says that

χ=constant, on the menisci. (21)

Actually, w(z) will be found parametrically as a function of ζ. The solution for the composed function W(ζ)≡w(Z(ζ)) is easily confirmed to be the analytic function

$$W ( ζ ) = i - \frac{1}{π} log ζ . \qquad ( 22 )$$

It is clear that Re[W(ζ)]=χ=−(ΔT/π)log |ζ| is constant on |ζ|=1, ρ, which means that (21) is satisfied. It can also be checked that

$$Im [ W ( ζ ) ] = T = 1 - \frac{arg [ ζ ]}{π} = \{ \begin{matrix}1 , & arg [ ζ ] = 0 , \\ 0 , & arg [ ζ ] = π ,\end{matrix} \qquad ( 23 )$$

which means that (18) is satisfied because the positive and negative portions of the real ζ axis inside the annulus ρ<|ζ|<1 correspond to the hot and cold plates, respectively. The temperature T*(x*, y*) therefore follows from the explicit parametric solution summarized in (1) upon multiplying by ΔT*.

### Solution for the Flow

Solving for the incompressible Stokes flow generated in the upper half plane is more challenging but, again, a parametric solution using the ζ variable is possible. The flow has an associated biharmonic stream function that can be represented as

ψ(x,y)=Im[z̅f(z)+g(z)], z=x+iy, (24)

where the two analytic functions f(z) and g(z) are known as Goursat functions. The following relations between the Goursat functions and the physical variables can be derived:

$$4 {f}^{′} ( 𝓏 ) = p - i ω , u = iv = - \overline{f ( 𝓏 )} + \overline{𝓏} {f}^{′} ( 𝓏 ) + {g}^{′} ( 𝓏 ) , {e}_{11} + {ie}_{12} = 𝓏 \overline{{f}^{″} ( 𝓏 )} + \overline{{g}^{″} ( 𝓏 )} , \qquad ( 25 )$$

where p is the liquid pressure, ω is the vorticity, eᵢⱼ is the rate-of-strain tensor, and primes denote differentiation with respect to z. Since liquid penetrates neither the plates nor the menisci the x-axis must be a streamline and the choice

g(z)=−zf(z) (26)

ensures this. It follows from the use of (26) in (25) that

U(x)=−f(z)−f̅(̅z̅)̅, H≡f(z)+zf̅′̅(̅z̅)̅+g̅′̅(̅z̅)̅=f(z)−f̅(̅z̅)̅, (27)

where U(x) denotes the slip velocity in the x direction on y=0. The quantity H is useful because the Marangoni condition on the interface can be written in terms of it:

$$- 2 i \frac{dH}{dx} = - \frac{\partial σ}{\partial x} = \frac{\partial T}{\partial x} , \qquad ( 28 )$$

where (4) was used. It follows on integration of (28) with respect to x that

−2iH=T (29)

where an additive degree of freedom in the specification of f(z) has allowed setting a constant of integration to zero without loss of generality. But on use of (27) this implies that, on the menisci,

$$4 Im [ f \vert ( 𝓏 ) ] = T , - 2 Re [ f ( 𝓏 ) ] = U or f ( 𝓏 ) = - \frac{U}{2} + \frac{iT}{4} . \qquad ( 30 )$$

Since the solution to the temperature problem has already been found, the temperature, and hence the imaginary part of f(z), on the menisci are known quantities. On defining a modified analytic function h(z) via

$$f ( 𝓏 ) = \frac{i}{4} h ( 𝓏 ) \qquad ( 31 )$$

and introducing H(ζ)=h(Z(ζ)), it can be written as

$$Re [ ℋ ( ζ ) ] = \{ \begin{matrix}Re [ W ( ζ ) ] = 1 - θ / π , & ζ = {e}^{i θ} , 0 \leq θ \leq π , \\ Re [ W ( ζ ) ] = 1 - θ / π , & ζ = ρ {e}^{i θ} , 0 \leq θ \leq π .\end{matrix} \qquad ( 32 )$$

Thus the real part of H(ζ) is known on the two semi-circular boundaries of the annulus in the upper half plane. On the plates, which are solid surfaces, a no-slip condition must be imposed; this means that U=0 there and

Im[ [symbol] (ζ)]=0, for ζ̅=ζ. (33)

The latter condition implies

[symbol]

(ζ)= [symbol] (ζ), (34)

where the Schwarz conjugate function has been introduced to H(ζ) defined by H̅(ζ)≡H̅(̅ζ̅)̅. Relation (34) can be used to infer the boundary data on the real part of H(ζ) on the lower-half semi-circles

$${C}_{0}^{-} , {C}_{1}^{-} .$$

### Suppose

$$ζ ∈ {C}_{0}^{-} ,$$

or ζ=e^{iθ} for −π≤θ≤0, then

$$ζ ∈ {C}_{0}^{+} ;$$

similarly, if

$$ζ ∈ {C}_{1}^{-} ,$$

or ζ=ρe^{iθ}, then

$$ζ ∈ {C}_{1}^{+} .$$

It can therefore be inferred that

$$Re [ ℋ ( ζ ) ] = Re [ \overline{ℋ ( ζ )} ] = Re [ ℋ ( \overline{ζ} ) ] = \{ \begin{matrix}1 + θ / π , & ζ = {e}^{i θ} , - π \leq θ \leq 0 , \\ 1 + θ / π , & ζ = ρ {e}^{i θ} , - π \leq θ \leq 0.\end{matrix} \qquad ( 35 )$$

The first equation follows from the fact that the real parts of complex conjugate quantities are equal, in the second equality (34) has been used, while the third equality follows on use of (32). By these considerations the problem has been reduced to a so-called modified Schwarz problem on the concentric annulus: this is the problem of finding a (single-valued) analytic function in the annulus given its real part on the boundaries. In this case, (32) furnishes the real part of H(ζ) on the upper half circles

$${C}_{0}^{+} , {C}_{1}^{+}$$

and (35) on the lower half circles

$${C}_{0}^{-} , {C}_{1}^{-} .$$

There is a solvability condition on this specified data for such a single-valued function H(ζ) to exist—it will appear later in (44)—however it is easily checked that the data in (32) and (35) satisfy this condition.

One way to solve this modified Schwarz problem is to use the so-called Villat integral formula. However, another approach is more convenient. Since H(ζ) is known to be analytic and single-valued in the annulus ρ<|ζ|<1 it can be written as the convergent Laurent series

$$ℋ ( ζ ) = {\sum }_{n = 0}^{∞} {a}_{n} {ζ}^{n} + {\sum }_{n = 1}^{∞} \frac{{a}_{- n} {ρ}^{n}}{{ζ}^{n}} . \qquad ( 36 )$$

The coefficients {aₙ} must be real because of condition (34). It is also known that H(ζ) satisfies boundary conditions of the form

$$Re [ ℋ ( ζ ) ] = \{ \begin{matrix}d ( ζ ) , & on \vert ζ \vert = 1 , \\ e ( ζ ) , & on \vert ζ \vert = ρ ,\end{matrix} \qquad ( 37 )$$

where it is assumed that the data on each circle have Fourier series representations of the form

$$d ( ζ ) = {\sum }_{n = - ∞}^{∞} {d}_{n} {e}^{in θ} , e ( ζ ) = {\sum }_{n = - ∞}^{∞} {e}_{n} {e}^{in θ} , \qquad ( 38 )$$

where d−n=dn and e−n=en. Then on substitution of (36) into the first boundary condition on |ζ|=1 and on equating positive powers of ζ it follows that

αₙ+α̅₋̅ₙ̅ρⁿ=2dₙ, n≥1. (39)

The coefficients of the negative powers give no new information. On setting ζ→ρζ and substituting into the second boundary condition on |ζ|=ρ then, after equating positive powers of ζ, it is found that

αₙρⁿ+α̅₋̅ₙ̅=2eₙ, n≥1. (40)

Solving (39) and (40) then gives

$${a}_{n} = \frac{2 ( {d}_{n} - {ρ}^{n} {e}_{n} )}{1 - {ρ}^{2 n}} , n \geq 1 \qquad ( 41 )$$

$$and$$

$${a}_{- n} = \frac{2 \overline{{e}_{n}} - 2 {ρ}^{n} \overline{{d}_{n}}}{1 - {ρ}^{2 n}} , \vert n \geq 1. \qquad ( 42 )$$

It must also be true that

Re[α₀]=d₀ (43)

and, for consistency, the data must satisfy

e₀=d₀ (44)

which is precisely the solvability condition mentioned earlier.

The next piece of information needed is the following Fourier cosine series

$$\frac{1}{2} + {\sum }_{n \geq 1} \frac{2 ( {( - 1 )}^{n} - 1 )}{{( π n )}^{2}} cos n θ = \{ \begin{matrix}θ / π , & 0 \leq θ \leq π , \\ - θ / π , & - π \leq θ \leq 0 ,\end{matrix} \qquad ( 45 )$$

which follow from a straightforward calculus exercise. This means that for the problem considered here,

$$d ( ζ ) = e ( ζ ) = \frac{1}{2} - {\sum }_{n \geq 1} \frac{( {( - 1 )}^{n} - 1 )}{{( π n )}^{2}} ( {e}^{in θ} + {e}^{- in θ} ) \qquad ( 46 )$$

form which the required coefficients are read off as

$${d}_{0} = {ε}_{0} = \frac{1}{2} , {d}_{n} = {e}_{n} = \frac{1 - {( - 1 )}^{2}}{{( π n )}^{2}} . \qquad ( 47 )$$

Therefore, use of these in (41)-(43) yields

$${a}_{0} = \frac{1}{2} , \qquad ( 48 )$$

$${a}_{n} = {a}_{- n} = \frac{2 {d}_{n} ( 1 - {ρ}^{n} )}{1 - {ρ}^{2 n}} = \frac{2 {d}_{n}}{1 + \vert {ρ}^{n}} = \frac{2}{1 + {ρ}^{n}} ( \frac{1 - {( - 1 )}^{2}}{{( π n )}^{2}} ) , n \geq 1.$$

The solution for H(ζ) now follows from (36) with coefficients given by (48):

$$ℋ ( ζ ) = \frac{1}{2} + {\sum }_{n \geq 1}^{∞} \frac{2}{1 + {ρ}^{n}} ( \frac{1 - {( - 1 )}^{2}}{{( π n )}^{2}} ) ( {ζ}^{n} + \frac{{ρ}^{n}}{{ζ}^{n}} ) + ic , c ∈ ℝ . \qquad ( 49 )$$

The imaginary part of H(ζ) is not fixed by the modified Schwarz problem. But, from (31), the required Goursat function determining the flow is

$$f ( z ) = \frac{i}{4} h ( z ) = \frac{i}{4} [ \frac{1}{2} + {\sum }_{n \geq 1}^{∞} \frac{2}{1 + {ρ}^{n}} ( \frac{1 - {( - 1 )}^{n}}{{( π n )}^{2}} ) ( {ζ}^{n} + \frac{{ρ}^{n}}{{ζ}^{n}} ) ] , \qquad ( 50 )$$

where the no-slip condition when ζ is on the real axis necessitates the choice c=0. On substitution of the solution (50) for f(z) into (24) with the choice (26) the stream function reported in (1) follows after multiplication by β*ΔT*/μ*.

### Pumping Speed

Having solved for the flow field, the non-dimensional pumping speed, denoted by U_{∞}, follows by examining its far-field form, i.e. u−iv→U∞ as y→∞. It follows from (14) that

$$\begin{matrix}u - iv = - \overline{f ( z )} + \overline{z} {f}^{′} ( z ) + {g}^{′} ( z ) = - \overline{f ( z )} + \overline{z} {f}^{′} - {zf}^{′} ( z ) - f ( z ) . \\ = - \overline{f ( z )} - 2 {iuf}^{′} ( z ) - f ( z ) .\end{matrix} \qquad ( 51 )$$

$$Since$$

$$f ( z ) \to {f}_{∞} + 𝒪 ( 1 / z ) , as z \to ∞ \qquad ( 52 )$$

$$then {f}^{′} ( z ) \to O ( 1 / {z}^{2} ) and$$

$$u - iv \to - 2 Re [ {f}_{∞} ] ≡ {U}_{∞} , as y \to ∞ . \qquad ( 53 )$$

But ζ=α is the preimage of the point at infinity y→∞ in the principal period window,

$$so$$

$${f}_{∞} = \frac{i}{4} [ \frac{1}{2} {\sum }_{n \geq 1}^{∞} \frac{2}{1 + {ρ}^{n}} ( \frac{1 - {( - 1 )}^{n}}{{( π n )}^{2}} ) ( {α}^{n} + \frac{{ρ}^{n}}{{α}^{n}} ) ] \qquad ( 54 )$$

$$therefore$$

$${U}_{∞} = - 2 Re [ {f}_{∞} ] = Im [ {\sum }_{n \geq 1}^{∞} \frac{2}{1 + {ρ}^{n}} ( \frac{1 - {( - 1 )}^{n}}{{( π n )}^{2}} ) ( {α}^{n} + \frac{{ρ}^{n}}{{α}^{n}} ) ] . \qquad ( 55 )$$

The terms corresponding to even n vanish and can be written n=2m−1 for m≥1 giving

$${U}_{∞} = \frac{2}{{π}^{2}} Im [ {\sum }_{m \geq 1}^{∞} \frac{1}{{( 2 m - 1 )}^{2} ( 1 + {ρ}^{2 m - 1} )} ( {α}^{2 m - 1} + \frac{{ρ}^{n}}{{α}^{2 m - 1}} ) ] . \qquad ( 56 )$$

But α=ir so that, for n=2m−1,

$${α}^{n} = {i ( - 1 )}^{m + 1} {r}^{2 m - 1} , \frac{{ρ}^{n}}{{α}^{n}} = ∓ {i ( - 1 )}^{m + 1} {( \frac{ρ}{r} )}^{2 m ⊢ 1} . \qquad ( 57 )$$

This means

$${U}_{∞} = \frac{2}{{π}^{2}} {\sum }_{m \geq 1}^{∞} \frac{{( - 1 )}^{m + 1}}{{( 2 m - 1 )}^{2} ( 1 + {ρ}^{2 m - 1} )} ( {r}^{2 m - 1} - {( \frac{ρ}{r} )}^{2 m - 1} ) \qquad ( 58 )$$

which is an explicit formula for the non-dimensional pumping speed as a function of r and ρ. If r=√ρ inspection of the formula reveals that U_{∞}=0 since then all the terms in the sum vanish. This corresponds to the case where the menisci have equal length and there is no pumping, only recirculatory mixing, in the fluid generated by the thermocapillary stress.

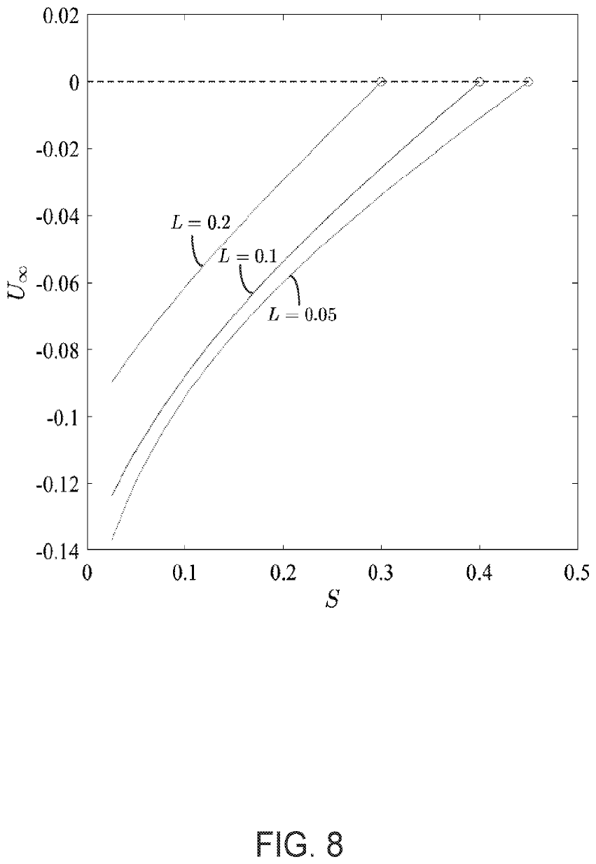

FIG. 8 shows a graph of U_{∞} as a function of the separation parameter S for three different choices of the plate length L=0.05, 0.1 and 0.2. When S=(1−2L)/2 the menisci have the same length and there is no pumping, as expected. However, as S decreases from this value the liquid is pumped to he left with increasing speed as S decreases. The loss of symmetry between the two menisci is responsible for this net pumping effect. Interestingly, the flow direction is selected by the longer meniscus.

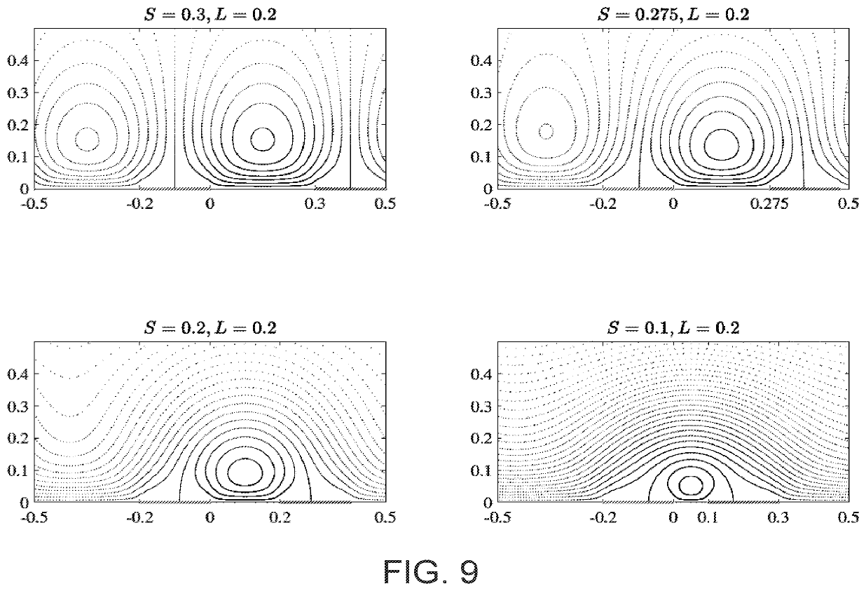

FIG. 9, which shows typical streamlines for L=0.2 and for different values of the separation parameter S, illustrates how a pure mixing flow when S=(1−2L)/2=0.3 develops a net pumping component as S gradually decreases from this value.

### Reciprocal Theorem

It turns out that another explicit formula for the net pumping speed can be found that is distinct from, but produces the same results as, the formula (58) already found. This formula emerges from the reciprocal theorem for Stokes flow combined with use of previously derived exact solutions for longitudinal flow over a superhydrophobic surface with two no-shear menisci per period. Interestingly, this second formula for the pumping speed can be derived without any need to solve for the flow field. This alternative determination of the pumping speed only requires knowledge of the Marangoni stress on the menisci which might feasibly be caused by many other physical mechanisms besides that due to thermocapillarity as envisaged here. Consequently, the analysis to follow may well be useful in determining the pumping speed for many other problems in the same domain architecture.

The reciprocal theorem for Stokes flow is an integral relation between two solutions of the Stokes equations, {uᵢ, σᵢⱼ} and {ûᵢ,\hat{σ}ᵢⱼ} say, taking place in the same domain D. Specifically,

[symbol]

uᵢ\hat{σ}ᵢⱼnⱼds= [symbol] ûᵢσᵢⱼnⱼds, (59)

where d is the arclength element around the boundary ∂D of a period window and nⱼ denotes the components of the outward unit normal vector. Suppose that {ûᵢ, \hat{σ}ᵢⱼ} is the solution to the thermocapillary pump problem and that {uᵢ, σᵢⱼ} is that for simple shear flow over a periodic superhydrophobic surface with two shear-free menisci per period. On the use of the periodicity of both solutions, which means that all contributions to both integrals from the sides of the window cancel out, the only contribution to the integral on the right hand side arises from y→∞ and equals −U_{∞}. Then, with a careful evaluation of the contributions around ∂D, and use of the periodicity of both solutions, one notices that the left hand side of (59) reduces to

$${U}_{∞} = - {\int }_{meniscus 1} {u}_{i} {M}_{i}^{( 1 )} ds - {\int }_{meniscus 2} {u}_{i} {M}_{i}^{( 2 )} ds , \qquad ( 60 )$$

where

$${M}_{i}^{( k )}$$

denotes the Marangoni stress on the k-th meniscus. Formula (60) gives a formula for the pumping speed U_{∞} for any given interfacial Marangoni stresses—not just those relevant to the thermocapillary pump of interest here—provided uᵢ is known. But an exact solution to precisely that problem has been found by Crowdy in a study of superhydrophobic surfaces having more than one shear-free meniscus per period. Formula (60), in combination with the exact solution of Crowdy, therefore provides a valuable formula for the pump speed due to any form of imposed Marangoni stress.

Since this paper has adopted a complex variable formulation, all that remains is to rephrase formula (60) in the same language. Since, in complex variable notation,

$${u}_{i} {σ}_{ij} {n}_{j} ↦ Re [ ( u - iv ) ( - 2 i \frac{dH}{ds} ) ] , \qquad ( 61 )$$

where H(z, z̅)=f(z)+zf̅′̅(̅z̅)̅+g̅′̅(̅z̅)̅ then the reciprocal theorem (59) can also be stated as

∫_{∂D}Re[(u−iv)(−2idĤ)]=∫_{∂D}Re[(û−i\hat{v})(−2idH)]. (62)

Supposing now that ∂D is the boundary of a period window for the interdigitated thermocapillary pump. On y=0,

u−iv=−2Re[f(z)], û−i\hat{v}=−2Re[\hat{f}(z)] (63)

and

H=2iIm[f(z)], Ĥ=2iIm[\hat{f}(z)]. (64)

The form of f(z) relevant to the problem of transverse flow, with unit shear rate, over a superhydrophobic surface comprising two shear-free menisci in each period window occupying the same intervals as the menisci in the thermocapillary pump was determined in Crowdy to be

$$f ( z ) = - \frac{1}{8 π} log ( \frac{P ( ζ / α , ρ ) P \vert ( ζ \overline{α} , ρ )}{P ( ζ / \overline{α} , ρ ) P \vert ( ζα , ρ )} ) . \qquad ( 65 )$$

Interestingly, the same function P(ζ, ρ), defined in (12) and appearing in the conformal mapping function, also appears in this formula (65) for f(z). Note that, as required by the superhydrophobic surface problem,

$$f ( z ) \to \frac{iz}{4} , as y \to ∞ . \qquad ( 66 )$$

Consequently, the statement (62) of the reciprocal theorem becomes

$${\int }_{- 1 / 2}^{1 / 2} Re [ f ( z ) ] Im [ d \hat{f} ( z ) ] = {\int }_{- 1 / 2}^{1 / 2} Re [ \hat{f} ( z ) ] Im [ df ( z ) ] - ( \frac{{U}_{∞}}{8} \times \frac{1}{4} ) , \qquad ( 67 )$$

where, as y→∞, Im[df(z)]=dx/4 and −2Re[f(z)]→U∞. But this simplifies to

$${\int }_{- 1 / 2}^{1 / 2} Re [ f ( z ) ] Im [ d \hat{f} ( z ) ] = - \frac{{U}_{∞}}{8} \qquad ( 68 )$$

because Re[\hat{f}(z)]=0 on the no-slip walls and Im[df(z)]=0 on the menisci: recall that, in the superhydrophobic surface problem considered in Crowdy the menisci are free of shear, and it is this feature that makes it the ideal choice of comparison problem here. Now recall that the Marangoni condition (28) for the thermocapillary pump problem is

$$- 2 i \frac{dH}{dx} = - \frac{\partial σ}{\partial x} = \frac{\partial T}{\partial x} , or - 2 id \hat{H} = dT \qquad ( 69 )$$

and Ĥ=2iIm[\hat{f}(z)] hence

4Im[d\hat{f}(z)]=dT. (70)

But from the complex potential (1) for the temperature field, and, since χ is constant on the menisci,

$$idT = - \frac{d ζ}{πζ} , or dT = - \frac{d ζ}{i πζ} , \qquad ( 71 )$$

$$Hence ,$$

$$4 Im [ d \hat{f} ( z ) ] = - \frac{d ζ}{i πζ} . \qquad ( 72 )$$

Finally, use of (65) and (72) in (68), and on writing the integral over C+0 and C+1 (traversed anti-clockwise) and multiplying by β*ΔT*/μ* yields formula (3).

It can be checked numerically that the integral expression (3) gives the same result as the dimensional form of the infinite sum expression (58) found by solving for the entire flow field. This provides reassuring corroborating checks on both analytical approaches.

### Numerical Corroboration

As a check on analytical solutions above a fully numerical method was used to solve this problem. To do this, a two-dimensional Chebyshev psuedospectral method was used. The periodic domain was split into either 4 or 5 subdomains, one over each meniscus, one above the hot plate and another above the cold plate (two if the cold plate was split by the period line). Each subdomain was than discretized into an N×M collocation grid with Gauss-Lobatto spacing in both directions. Since the temperature field is independent of the velocity field in the zero Péclet number limit, it was solved for first. A 5MN×5MN matrix, denoted by A, was built satisfying Laplace's equation on the interior points and the relevant boundary conditions at boundary points. Solution of the temperature reduces to solution of the matrix system

A\vec{T}ₙᵤₘ=\vec{F}ₙᵤₘ, (73)

where \vec{T}ₙᵤₘ is a vector containing the unknown temperatures at the collocation points and Fₙᵤₘ is a forcing vector and non-zero only at points corresponding to the hot plate. The linear system is readily solved using standard methods.

After determining \vec{T}ₙᵤₘ, the thermocapillary stress can be extracted and fed into a steady-state solver for the hydrodynamic problem. A vorticity stream fuction formulation is used to avoid solving the fourth-order Stokes equations. Since this requires solving for the two unknowns, ψₙᵤₘ and ωₙᵤₘₒωnum, the numerical stream function and vorticity, respectively, the resulting matrix system has size 10MN×10MN but it is similarly solvable using standard methods.

To compare the numerical solution with its analytical counterpart, the average velocity of the numerical solution was calculated far from the composite interface. This gave a numerical estimation of U_{∞}. Agreement with the analytical solution is excellent, but to achieve good accuracy the truncation choices N=21 and M=31 are necessary resulting in large matrices to invert. This underscores the value in having available an analytical solution (58), especially for purposes of device optimization involving extensive calculations over design parameter sweeps.

Finally, to evaluate the domain of validity of the model, the numerical code described above was adapted to allow for solutions at arbitrary Pe. This was done by adding a pseudo-time to the temperature problem and running until a steady-state was reached.

### Device Metrics

There are two parameters of chief importance in quantifying the engineering viability of the thermocapillary pump: the pumping speed, U_{∞}*, and the heat load per unit depth required along the hot ridge, which is herein called q_{c}*. The heat load is obtaining by integrating the normal derivative of the temperature field over the hot ridge and multiplying by the thermal conductivity of the liquid k₁*, according to Fourier's law:

$${q}_{c}^{*} = {\int }_{- {L}^{*}}^{0} {k}_{1}^{*} \frac{\partial {T}^{*}}{\partial {y}^{*}} {dx}^{*} . \qquad ( 74 )$$

Only the heat load associated with the hot ridge is relevant since this is the only actively heated element, see FIG. 3. This merits introduction of a dimensionless heat q_{c}=q_{c}*/(k₁*ΔT*), which is independent of the period length D* due to the integration along the ridge. On plugging the dimensionless parameters into (74) and using one of the Cauchy-Riemann equations it follows that

$${q}_{c} = - \frac{1}{π} log ρ . \qquad ( 75 )$$

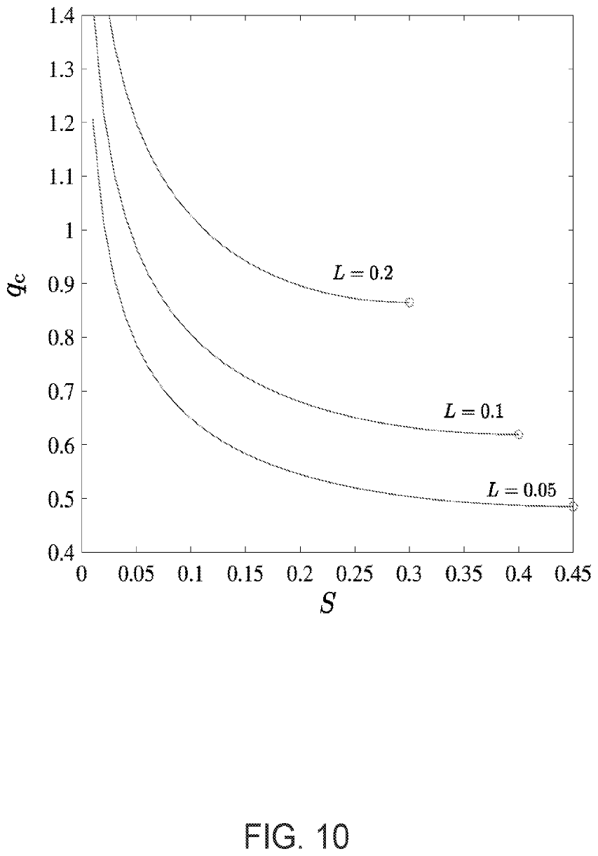

Of interest is the relationship between the geometric parameters S and L and the two parameters U_{∞} and q_{c}. FIG. 8, already discussed in the Pumping speed section above, shows that |U_{∞}| increases monotonically as both S→0 and L→0. This implies that pumping speed will be maximized when both S and L are very small. To prompt a similar qualitative analysis for the heat load, FIG. 10 depicts the effect of S and L on q_{c}. It shows that |q_{c}| increases monotonically as S→0, but decreases as L→0. These are both unsurprising. First, if L is held constant as S→0, the two isothermal ridges approach each other and the temperature field becomes more singular, increasing the heat load. Conversely, if S is held constant and L→0, the total available area of heat transfer vanishes, reducing the heat load.

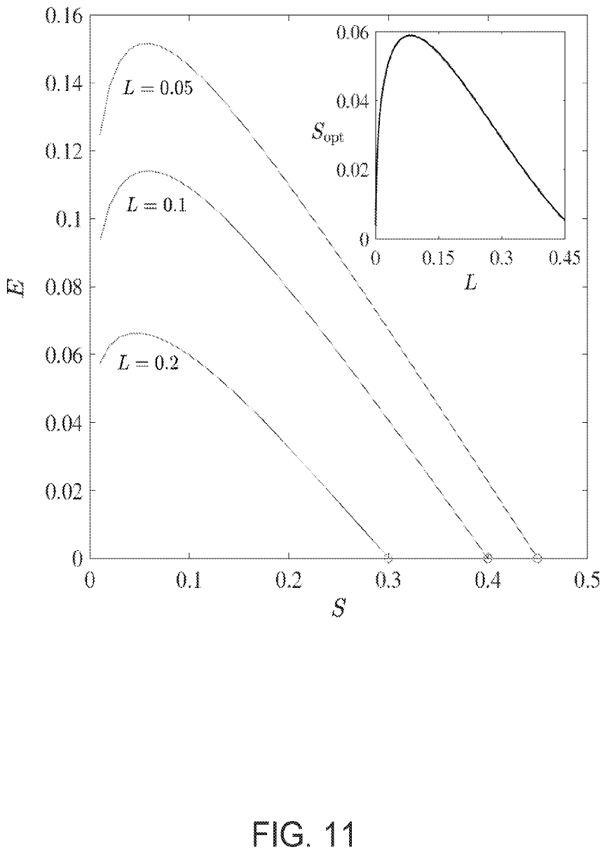

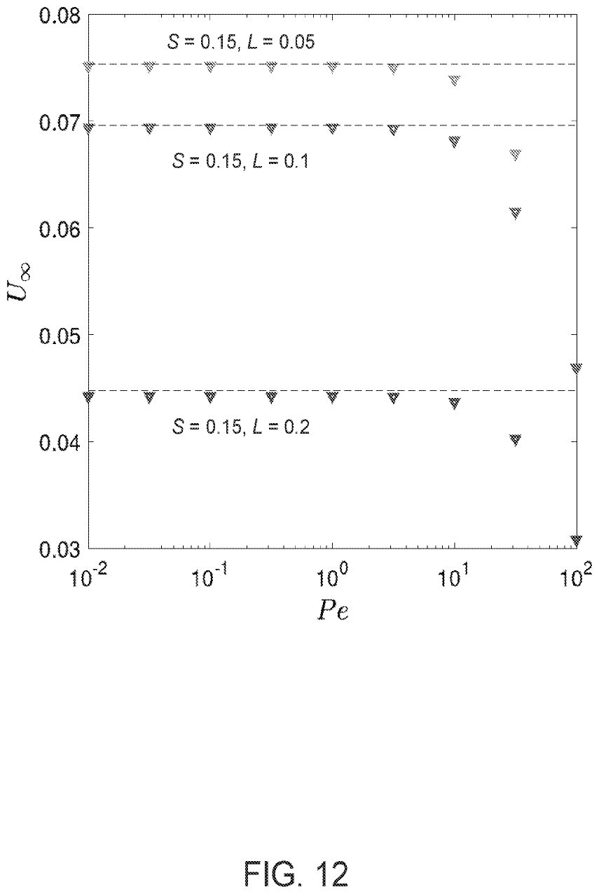

To summarize the relationships, |U_{∞}| is increased and |qc| is decreased as L→0, implying a small L is always preferred. Conversely, both are increased as S→0, which hints at a possible competition between pumping power and heat load. To examine this competition, an efficiency parameter, E=U_{∞}/q_{c} is defined which is the dimensionless ratio of pumping speed to pumping power. FIG. 11 plots E for different values of L and S. Notably, there is a value of S, which is herein called Sₒₚₜ, that yields a clear maximum efficiency for each choice of L. This happens because although |U_{∞}| increases as S→0, the heat load required increases much faster, reducing efficiency. A root finder was used to calculate Sₒₚₜ for a chosen L. The results are plotted in the inset of FIG. 11. Interestingly, Sₒₚₜ itself has a maximum at L≈0.0875. This shows there is a maximum spacing length for all L above which E is always non-optimal.

### Illustrative Calculations

The purpose of this section is to document some example calculations and test some of the limits of the assumptions. The values of the geometric parameters corresponding to the maximum value of Sₒₚₜ are chosen, that is L=0.0875 and S=0.058. With this S and L, and solving (58), the dimensionless pumping speed is |U_{∞}|=0.109. Solving (75) gives the dimensionless heat load as |q_{c}|=0.893. To obtain U_{∞}* and q_{c}*, their dimensionless forms need to be multiplied by β*ΔT*/μ* and k₁*ΔT*, respectively. If the liquid is taken to be water then μ*=10⁻³ kgs⁻¹m⁻¹, k₁*=0.598 Wm⁻¹K⁻¹ and βμ*=1.65×10⁻⁴ Nm⁻¹K⁻¹. With ΔTμ*=1° C., the result is |U_{∞}*|=0.018 ms⁻¹ and |q_{c}*|=0.534 Wm⁻¹. These dimensional values are both independent of D*: the role of D* is simply to inform how many periods there are, which plays a role in the total amount of power required for this pump. For example, if it is assumed there is a 2 cm long microchannel that is 1 cm wide, then with D*=200 μm there are a total of 100 ridges to heat. The total heat load is then 0.534 W. If, however, the period length is 2 mm there are only 10 hot ridges per channel and the heat load required is reduced to 0.0534 W.

By way of comparison, Baier et al. (Proc. of 14^{th} International Conference on Miniaturized System for Chemistry and Life Sciences, 1799-1801, (2010)) numerically investigated a thermocapillary driven pump in which a linear temperature gradient was imposed on a superhydrophobic substrate. In their set-up the ridges are equi-spaced and oriented perpendicular to the desired flow direction; they are additionally taken to be isothermal so that the linear drop in temperature between neighboring ridges yields a thermocapillary stress that pumps the flow. The full multiphysics problem was solved in COMSOL capturing both inertial and advective effects, which have been ignored here. When the free surface fraction, defined as meniscus length divided by period length, is 0.8, they find temperature gradients of 600° Cm⁻¹ and 1900° Cm⁻¹ generated far-field flow rates of water of 1.7 mm/s and 3.2 mm/s, respectively. For the geometry, an analog to this temperature gradient parameter is ΔT*/D*. Assuming D*=200 μm, the ΔT* corresponding to the two temperature gradients is ΔT*=0.12° C. and ΔT*=0.38° C. Since a free surface fraction of 0.8 corresponds to when L=0.1, U_{∞}* can be solved to compare. The value S=0.0584 is chosen to maximize the efficiency. If the liquid is water the values U_{inf}*=2.09 mm/s and U_{inf}* inf=6.6 mm/s are found for the two different temperatures. This indicates that the asymmetric pump proposed here can achieve at least the same order of magnitude of flow rate as the alternative pump suggested by Baier et al., Moreover, the asymmetric pump has the advantage that the average liquid temperature does not change as the flow travels downstream. This means there is no limitation of the channel length (due to freezing) and that, in practice, ΔT*/D* can be set to significantly higher values than the temperature gradient in Baier et al., resulting in higher velocities. For example, setting ΔT=12° C. means U_{∞}*=20.9 mm/s. However, this corresponds to a temperature gradient of 6000° Cm⁻¹ in the pump proposed in Baier et al. where the temperature of a 2 cm channel would go from 100° C. at the inlet to −20° C. out the outlet.

The pumping speed estimates here are of the same order of magnitude as those given by Baier et al., but significant discrepancies appear for the higher temperature case. These can be attributed to an increase in both Re and Pe. Using the far-field velocity as the velocity scale and taking ρ*=997 kg/m³ and α=0.14×10-6 m²/s, then Re=0.41 and Pe=2.99 for ΔT*=0.12° C. For ΔT*=0.38° C. these values rise to Re=1.31 and Pe=9.42. This calls into question the Stokes flow and zero Pe assumptions when the far field velocity is large. FIG. 11 tests the small Pe assumption by plotting the analytical results against pumping speeds for various Pe. It shows that the results are a good estimate up to Pe=O(1). Therefore, it is expected that the results to be accurate up to this value.

It is noted that other liquids maybe considered as well. For example, Galinstan, a non-toxic replacement for mercury or mercury itself may be pumped. Notably, the surface tension of mercury is a stronger function of temperature than water; e.g., 40% higher between 15° and 50° C. Also, the use of liquid metals has other implications. First, they are non-volatile; consequently, phase change (evaporation and condensation) along menisci, especially near triple-contact lines will be negligible effects, albeit not so in water for sufficiently-large ΔT. Secondly, the absence of a sub-phase (e.g., water vapor in the case of water substantively above room temperature) implies no adverse shear stress are exerted by it along menisci. Finally, menisci in liquid metals may be less susceptible to immobilization via the presence of surfactants as may occur with water, especially if they are short.

The theoretical thermocapillary pump put forward here has all the same advantages of the electroosmotic pump proposed by Adjari. It has no moving parts and the asymmetry responsible for pumping is built into the fixed device architecture and does not rely, for example, on the continuous production of discrete droplets as required in many devices that leverage electrowetting effects. Moreover, it does not rely on the imposition of an external pressure gradient, or any other external electric field or thermal gradient; indeed the device is thermally adiabatic with no net heat generated in any period window. As a consequence, there is no physical limitations of the length of this pump beyond total energy consumed, making it attractive for applications where large pumping distances are required.

### Example 2

It is known that one may interdigitate asymmetric structures in a periodic array to pump fluid in a channel using various forces. For example, broken symmetry has been exploited in the context of an electro-osmotic pump, see Brown et al. (Physical Review E—Statistical Physics, Plasmas, Fluids, and Related Interdisciplinary Topics, 2001) and Urbanski et al. (Journal of Colloid and Interface Science, 309(2), 332-341, 2007). Herein it is shown how this can be done using, e.g., thermocapillary- and Maxwell stress-based forces.

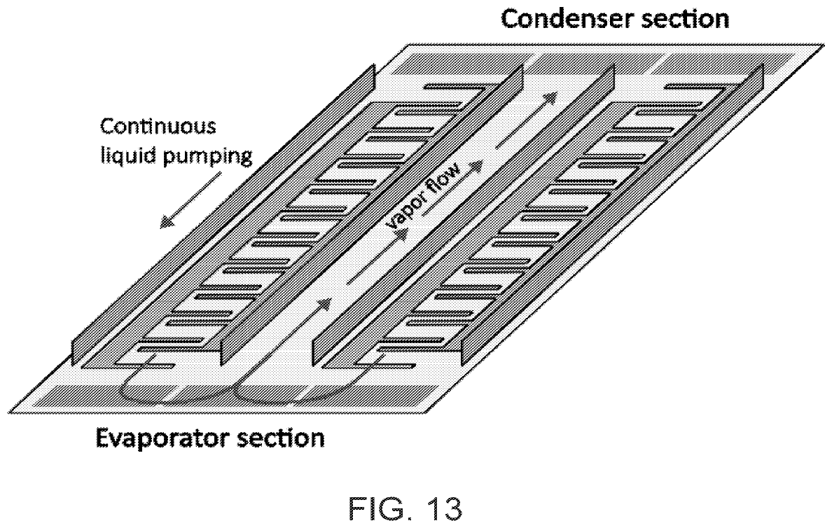

Although the physical mechanisms driving pumping differ, the basic idea behind both the thermocapillary and Maxwell stress induced pumping is the same. A set of two interdigitated structures are aligned asymmetrically such the spacing between consecutive digits is non-uniform. This is depicted in FIG. 13. Driving forces are generated by holding the two interlocking structures at different values of an important property, temperature in the case of thermocapillary stress and potential for Maxwell stress. This difference creates a stress field that drives fluid towards one of the interlocking structures. Since the gaps between the structures are non-uniform, the average stress generated in one period window is non-zero, inducing pumping. It is noted that thermocapillary-stress pumping requires the liquid to be in the Cassie-Baxter state atop textured surfaces where surface tension changes along menisci between the structures generate the flow. Maxwell-stress pumping does not require the use of textured surfaces; however, the interdigitated structures need to be electrically conducting electrodes. If the working fluid is water, these electrodes need to be covered with a thin dielectric layer to eliminate electrolysis.

Further, such a pump can be integrated into a heat pipe as shown in FIG. 13, whereby the aforementioned type of pump drives the flow in the adiabatic section. This resolves the aforementioned shortcomings in an Electronic Heat Pipe (EHP) and is the first time such a pump has been considered in the context of a heat pipe. The key is it enables heat pipes with arbitrarily-long adiabatic sections as performance limits are not constrained by capillary forces. This heat pipe retains all the other benefits of the EHP (reliability due to the absence of no moving parts very low power consumption, compact form factor, orientation independence). Importantly, it is significantly less complex to operate and easier, much less expensive to fabricate. This heat pipe may be called an Arbitrarily-Long Electronic Heat Pipe (ALEHP).

The salient points are that such structures would be used to pump the liquid through the adiabatic section in FIG. 13. In a non-limiting example, the vapor flow is shown adjacent to the liquid flow in FIG. 13, but may be positioned on top or beneath it.

A novel aspect of the systems described herein includes the combination of the two technologies in the context of a heat pipe. Several other embodiments of this technology are possible, including 3D heat pipe architectures, multi-evaporator heat pipes, heat pipes made of thermally conducting plastics etc.

The first major disclosure is the use of the asymmetric interdigitated architecture (AIA) as a basis for the adiabatic section of a heat pipe. This is a significant departure from its now well-studied use in microfluidic channels. Combining AIA with two new flow mechanisms more suited to this heat-pipe application is also disclosed: the “thermocapillary mechanism” and the “Maxwell-stress mechanism”.

The second disclosure is the novel use of thermocapillary stress over menisci as a choice for the flow mechanism. This requires the “gaps” in the AIA to be “menisci” between the fluid being pumped and a subphase fluid/gas phase (occupying grooves or plastrons). The actuators in this embodiment are solid surfaces maintained at different temperature, “hot” (or “+”) and “cold” (or “−”). Importantly, no net heat flux introduced per period, so the pump is adiabatic. The surface tension on the menisci is temperature dependent, with warmer parts of the meniscus having lower surface tensions. This causes a thermocapillary stress on the menisci, and a Marangoni stress on the working fluid, that is the flow mechanism causing a local tangential slip on the fluid. The asymmetry of the AIA leads naturally to left-right pumping. Even without the proposed specific application to the adiabatic section of a heat pipe, such a pumping mechanism has not previously been investigated.

A third disclosure is the novel use of Maxwell stresses to provide the flow mechanisms for AIA, again, as a basis for application to the adiabatic section of a heat pipe. The actuators in this embodiment are two electrodes, held at distinct voltages—one at unit voltage (“+”) and another grounded (“−”)—at the junction between two materials with distinct electrical conductivities and electrical permittivities. The upper material is taken to be the fluid required to be pumped. Electric field lines will join each electrode in each period window owing to their distinct electrifications. Another separate electric field will be imposed on the vertical direction to the periodic array of electrodes (parallel to the y-axis in an (x, y) plane if the periodic array of electrode pairs are along the x-axis). Since there will now be non-zero electric field components in both the x and y directions along the junctions between two materials (the “gaps”) there will be a non-zero tangential Maxwell stress on the fluid at this junction. By the asymmetry of the AIA, there will be a left-right imbalance causing the required net left-right pumping.

As used in this specification and the claims, the singular forms “a,” “an,” and “the” include plural forms unless the context clearly dictates otherwise.

As used herein, “about”, “approximately,” “substantially,” and “significantly” will be understood by persons of ordinary skill in the art and will vary to some extent on the context in which they are used. If there are uses of the term which are not clear to persons of ordinary skill in the art given the context in which it is used, “about” and “approximately” will mean up to plus or minus 10% of the particular term and “substantially” and “significantly” will mean more than plus or minus 100% a of the particular term.

As used herein, the terms “include” and “including” have the same meaning as the terms “comprise” and “comprising.” The terms “comprise” and “comprising” should be interpreted as being “open” transitional terms that permit the inclusion of additional components further to those components recited in the claims. The terms “consist” and “consisting of” should be interpreted as being “closed” transitional terms that do not permit the inclusion of additional components other than the components recited in the claims. The term “consisting essentially of” should be interpreted to be partially closed and allowing the inclusion only of additional components that do not fundamentally alter the nature of the claimed subject matter.

The phrase “such as” should be interpreted as “for example, including.” Moreover, the use of any and all exemplary language, including but not limited to “such as”, is intended merely to better illuminate the invention and does not pose a limitation on the scope of the invention unless otherwise claimed.

Furthermore, in those instances where a convention analogous to “at least one of A, B and C, etc.” is used, in general such a construction is intended in the sense of one having ordinary skill in the art would understand the convention (e.g., “a system having at least one of A, B and C” would include but not be limited to systems that have A alone, B alone, C alone, A and B together, A and C together, B and C together, and/or A, B, and C together.). It will be further understood by those within the art that virtually any disjunctive word and/or phrase presenting two or more alternative terms, whether in the description or figures, should be understood to contemplate the possibilities of including one of the terms, either of the terms, or both terms. For example, the phrase “A or B” will be understood to include the possibilities of “A” or “B” or “A and B.”

All language such as “up to,” “at least,” “greater than,” “less than,” and the like, include the number recited and refer to ranges which can subsequently be broken down into ranges and subranges. A range includes each individual member. Thus, for example, a group having 1-3 members refers to groups having 1, 2, or 3 members. Similarly, a group having 6 members refers to groups having 1, 2, 3, 4, or 6 members, and so forth.

The modal verb “may” refers to the preferred use or selection of one or more options or choices among the several described embodiments or features contained within the same. Where no options or choices are disclosed regarding a particular embodiment or feature contained in the same, the modal verb “may” refers to an affirmative act regarding how to make or use an aspect of a described embodiment or feature contained in the same, or a definitive decision to use a specific skill regarding a described embodiment or feature contained in the same. In this latter context, the modal verb “may” has the same meaning and connotation as the auxiliary verb “can.”

What is claimed is:

1. A microfluidic temperature control system comprising:
a microchannel;
a first plurality of ridges extending into the microchannel and thermally coupled to a first temperature;
a second plurality of ridges extending into the microchannel and thermally coupled to a second temperature, wherein the first plurality of ridges and the second plurality of ridges form an asymmetrical pattern in the microchannel such that liquid at adjacent ridges in the microchannel experience differing sign temperature gradients along menisci in a chosen direction; and
a controller configured to select the first temperature gradient and the second temperature gradient based on the first temperature and the second temperature to form a gradient of surface tension at the interface between two phases along the microchannel to pump liquid through the microchannel.

2. The system of claim 1, wherein each of the first plurality of ridges and the second plurality of ridges forms meniscus under adverse shear stress on a first side of a ridge and a meniscus under favorable shear stress on a second side of the ridge.

3. The system of claim 1, wherein the first temperature gradient achieves a first temperature at the first plurality of ridges extending into the microchannel that is less than a second temperature achieved by the second temperature gradient at the second plurality of ridges extending into the microchannel.

4. The system of claim 1, wherein the microchannel is one of a two-dimensional or three-dimensional geometry.

5. The system of claim 4, wherein the three-dimensional geometry is a rod.

6. The system of claim 5, wherein the rod is further coupled to a motor or mechanical load.

7. The system of claim 1, further comprising a heat source thermally coupled to the first plurality of ridges, configured to provide a thermal energy of the first temperature.

8. The system of claim 7, wherein the heat source is a microprocessor, power amplifier, high-power laser, smokestack, catalytic converter, or solar energy.

9. The system of claim 7, wherein at least a portion the first plurality of ridges includes a heating element thermally coupled to the heat source.

10. A method of operating a microfluidic pump comprising:
heating a first plurality of ridges extending into a microchannel;
cooling a second plurality of ridges extending into the microchannel, wherein the first plurality of ridges and the second plurality of ridges form an asymmetrical pattern in the microchannel such that liquid at adjacent ridges in the microchannel experience differing menisci; and
controlling the heating of the first plurality of ridges extending into the microchannel and the cooling of the second plurality of ridges extending into the microchannel to present Marangoni stresses induced by thermocapillarity in the microchannel.

11. The method of claim 10, wherein a working fluid is moved from a first end of the microchannel to a second end of the microchannel by the Marangoni stresses.

12. The method of claim 11, wherein cooling the second plurality of ridges includes passive or active cooling.

13. The method of claim 12, wherein passive cooling includes dissipating heat using a heat sink thermally coupled to the first plurality of ridges.

14. The method of claim 10, wherein the microchannel is one of a two-dimensional or three-dimensional geometry.

15. The method of claim 14, wherein the three-dimensional geometry is a rod.

16. The method of claim 15, wherein the rod spins in a first direction based on a first setting of the asymmetrical pattern.

17. The method of claim 16, wherein the rod spins in a second direction that is opposite the first direction based on a second setting of the asymmetrical pattern.

18. The method of claim 17, wherein at least one of the first plurality of ridges and second plurality of ridges are actuated to configure the microchannel in either the first setting or the second setting.

19. The method of claim 18, wherein the actuating at least one of the first plurality of ridges and second plurality of ridges is performed automatically or manually.

20. The method of claim 19, wherein automatic actuation is performed using a timer or rotation sensor.
